(19) United States
(12) Patent Application Publication
(10) Pub. No.: US 2025/0061795 A1
(43) Pub. Date: Feb. 20, 2025

(54) RESTAURANT SYSTEM, ALERTING METHOD AND STORAGE MEDIUM STORING ALERTING PROGRAM

(71) Applicant: Kura Sushi, Inc., Osaka (JP)

(72) Inventor: Kunihiko TANAKA, Osaka (JP)

(21) Appl. No.: 18/928,187

(22) Filed: Oct. 28, 2024

Related U.S. Application Data
(63) Continuation of application No. PCT/JP2024/001388, filed on Jan. 19, 2024.

(30) Foreign Application Priority Data
Feb. 22, 2023 (JP) 2023-025754

(51) Int. Cl. G08B 21/18; G06Q 30/04; G06V 20/50

(52) U.S. Cl. CPC G08B 21/18; G06Q 30/04; G06V 20/50

(57) ABSTRACT

A restaurant system provides an item to a seat used by a user in a restaurant. The restaurant system includes: a container that has a cover and is configured to house an item, the cover being selectively opened and closed; a conveying device that is configured to convey the item housed in the container; a change detection unit that is configured to detect, for the seat, a change in a state of the container that is being conveyed by the conveying device; a determination unit that is configured to determine whether a predetermined alert condition is met based on a detection result of the change detection unit; and an alert unit that is configured to output alert information indicating that an abnormality related to the container may have occurred upon determining that the alert condition is met by the determination unit.

### CROSS REFERENCE TO RELATED APPLICATION

This application is a continuation application of International Patent Application No. PCT/JP2024/001388 filed on Jan. 19, 2024, which designated the U.S. and claims the benefit of priority from Japanese Patent Application No. 2023-025754 filed on Feb. 22, 2023. The entire disclosure of the above application is incorporated herein by reference.

### TECHNICAL FIELD

The present disclosure relates to a restaurant system, an alerting method, and a non-transitory, computer readable, storage medium storing an alerting program for a restaurant that conveys an item housed in a container to a user by a conveying device.

### BACKGROUND

Conventionally, in a store such as a restaurant that provides items such as sushi, a conveying device having a conveying path is used. The conveying path extends along tables for users. In such a conveying device, an item can be served to a user by conveying the item to the user by setting the item on the conveying path.

In this way, in a restaurant that provides items using a conveying device, the item may be housed in a container.

For example, there has been known a configuration of a food management device for managing a food or a beverage housed in a container on a conveying path.

In addition, a user places an order for an item using a portable terminal or the like at each seat in a store such as a restaurant, for example.

### SUMMARY

In the event of an abnormality related to the container housing an item therein during conveyance by the conveying device, it is necessary to know that the abnormality may have occurred in order to deal with by related persons such as staffs at the store and customers of the store. However, in general, since the conveyance route of the conveying device is long, it is not practical for such relevant persons to constantly monitor whether an abnormality occurs.

One objective of the present disclosure is to provide a restaurant system, an alerting method, and a storage medium storing an alerting program when there is a possibility that an abnormality related to a container has occurred.

In a first aspect of the present disclosure, a restaurant system provides an item to a seat used by a user in a restaurant. The restaurant system includes: a container that has a cover and is configured to house an item, the cover being selectively opened and closed; a conveying device that is configured to convey the item housed in the container; a change detection unit that is configured to detect, for the seat, a change in a state of the container that is being conveyed by the conveying device; a determination unit that is configured to determine whether a predetermined alert condition is met based on a detection result of the change detection unit; and an alert unit that is configured to output alert information indicating that an abnormality related to the container may have occurred upon determining that the alert condition is met by the determination unit.

With such a configuration, it is possible to call attention to the possibility that an abnormality related to the container has occurred.

In a second aspect of the present disclosure, the restaurant system according to the first aspect further includes an inter-seats detection unit that is disposed along a conveying path of the conveying device, the inter-seats detection unit having a sensor that is configured to detect the container. The change detection unit includes: a first detection unit that is configured to detect information related to the state of the container conveyed to approach the seat based on a detection result of the seat inter-seat detection unit; and a second detection unit that is configured to detect information related to the state of the container conveyed to move away from the seat based on the detection result of the inter-seats detection unit.

With such a configuration, it is possible to detect a change in the state of the container according to the state of the container when the container is conveyed to the seat and conveyed out from the seat.

In a third aspect of the present disclosure, the restaurant system according to the second aspect, wherein each of the first detection unit and the second detection unit is configured to detect an open/close state of the cover of the container, and the alert condition is met when, for the container conveyed to the seat, the first detection unit detects an open state of the cover and the second detection unit detects a closed state of the cover.

With such a configuration, alert information can be output according to a change in the open/close state of the cover of the container.

In a fourth aspect of the present disclosure, the restaurant system according to the second aspect, wherein the inter-seats detection unit includes a camera that is configured to capture an image of an inside of the container when the cover of the container is opened, and each of the first detection unit and the second detection unit is configured to detect information related to the state of the container based on the image captured by the camera of the inter-seats detection unit.

With such a configuration, alert information can be output based on the result of captured images of the inside of the container.

In a fifth aspect of the present disclosure, the restaurant system according to the fourth aspect, wherein each of the first detection unit and the second detection unit is configured to detect information related to presence or absence of the item in the container based on the image captured by the camera, and the alert condition is met when, for the container conveyed to the seat, the first detection unit detects absence of the item in the container and the second detection unit detects presence of the item in the container.

With such a configuration, the alert information can be output according to the presence or absence of the container.

In a sixth aspect of the present disclosure, the restaurant system according to the first aspect, wherein the change detection unit is configured to continuously detect a change in an open/close state of the cover of the container that is being conveyed by the conveying device to the seat, and the alert condition is met when the open/close state of the cover of the container conveyed to the seat is detected to change from an open state to a closed state.

With such a configuration, the alert information can be output when the cover of the container being conveyed to the seat changes from the open state to the closed state.

In a seventh aspect of the present disclosure, the restaurant system according to the sixth aspect further includes an intermediate detection unit that has a camera configured to capture an image of an area through which the container passes after the container reached the seat until the container is conveyed out from the seat. The change detection unit is configured to detect a change in the open/close state of the cover of the container based on the image captured by the camera of the intermediate detection unit.

With such a configuration, it is possible to reliably detect the change in the state of the cover of the container that is being conveyed to the seat.

In an eighth aspect of the present disclosure, the restaurant system according to the sixth aspect, wherein the container has an open/close detection unit that is configured to detect the open/close state of the cover or a change in the open/close state, and the change detection unit is configured to acquire information indicating a detection result by the open/close detection unit.

With such a configuration, it is possible to reliably detect the change in the state of the cover of the container that is being conveyed to the seat.

In a ninth aspect of the present disclosure, the restaurant system according to the first aspect, wherein the change detection unit is configured to specify a container identifier for identifying the container as a detection target, and the alert unit is configured to output the alert information on the container identified by the container identifier in an output mode corresponding to the container identifier specified by the change detection unit.

With such a configuration, the alert information can be output in a corresponding manner for each container.

In a tenth aspect of the present disclosure, the restaurant system according to the ninth aspect, wherein the alert unit is further configured to output the alert information including information corresponding to the container identifier specified by the change detection unit as the alert information related to the container identified by the container identifier.

With such a configuration, the alert information including information corresponding to the container can be output.

In an eleventh aspect of the present disclosure, the restaurant system according to the ninth aspect, wherein the alert unit is configured to output the alert information on the container identified by the container identifier to an output destination corresponding to the container identifier specified by the change detection unit.

With such a configuration, the alert information can be output to the output destination corresponding to the container.

In a twelfth aspect of the present disclosure, the restaurant system according to the first aspect further includes a billing unit that is configured to charge the user corresponding to the seat based on a detection result of the change detection unit.

With such a configuration, the user can be charged according to the change in the state of the container at the seat.

In a thirteenth aspect of the present disclosure, an alerting method is implemented by a restaurant system including: a container that houses an item with a cover; a conveying device that conveys the item housed in the container; and a display device. The alerting method includes: a change detection step of detecting, for a seat, a change in a state of the container that is being conveyed by the conveying device; a determination step of determining whether a predetermined alert condition is met based on a detection result at the change detection step; and an alert step of outputting, to the display device, alert information indicating that an abnormality related to the container may have occurred upon determining that the alert condition is met at the determination step.

With such a configuration, if there is a possibility that an abnormality related to the container has occurred, it is possible to call attention to the possibility that an abnormality related to the container has occurred.

In a fourteenth aspect of the present disclosure, a non-transitory, computer readable, storage medium stores an alerting program for a restaurant system including: a container that houses an item with a cover; a conveying device that conveys the item housed in the container; and a display device. The alerting program, when executed by at least one processor of the restaurant system, causes the at least one processor to perform: a change detection step of detecting, for a seat, a change in a state of the container that is being conveyed by the conveying device; a determination step of determining whether a predetermined alert condition is met based on a detection result at the change detection step; and an alert step of outputting, to the display device, alert information indicating that an abnormality related to the container may have occurred upon determining that the alert condition is met at the determination step.

With such a configuration, if there is a possibility that an abnormality related to the container has occurred, it is possible to call attention to the possibility that an abnormality related to the container has occurred.

According to the restaurant system in the present disclosure, when there is a possibility that an abnormality related to the container has occurred, attention can be called to the possibility.

### BRIEF DESCRIPTION OF DRAWING

FIG. 1 is a diagram illustrating an example of a conveying device in a restaurant in which a restaurant system in the present embodiment is installed.

FIG. 2 is a plan view showing an example of the conveying device.

FIG. 3 is a block diagram of the restaurant system.

FIG. 4 is a diagram illustrating an example of user information used by an information processing device.

FIG. 5 is a diagram illustrating one example of detection results related to a state change accumulated by the information processing device.

FIG. 6 is a diagram illustrating one example of alert condition in the information processing device.

FIG. 7 is a flowchart illustrating one example of an operation by the information processing device.

FIG. 8 is a flowchart of one example of a change detection process performed by the information processing device.

FIG. 9 is a diagram illustrating an example of a screen in which a notification based on the alert information is made in a notification device.

FIG. 10 is a diagram illustrating another example of a screen in which a notification based on the alert information is made in a notification device.

FIG. 11 is a block diagram of a restaurant system according to a modification to the present embodiment.

FIG. 12 is a flowchart illustrating one example of a change detection process according to the modification.

FIG. 13 is a side view showing a schematic configuration of a container used in a restaurant system according to another modification to the present embodiment.

FIG. 14 is a block diagram of the restaurant system.

FIG. 15 is a schematic diagram of a computer system in the above embodiment.

FIG. 16 is a block diagram of the computer system.

### DESCRIPTION OF EMBODIMENTS

Hereinafter, embodiments of a restaurant system and the like will be described with reference to the drawings. In the embodiment, since the components having the same reference numerals perform the same operation, the description may be omitted again.

The terms used in the following are generally defined as follows. The meanings of these terms should not always be construed as indicated herein, but should be interpreted in light of their explanations, for example, if they are separately described below.

For a certain matter, an identifier is a character or code that uniquely indicates the matter. The identifier is, for example, an ID, but the type of the identifier does not matter as long as the identifier is information from which the corresponding matter can be identified. That is, the identifier may be the name of the thing itself that it indicates, or it may be a combination of signs or symbols so that they uniquely correspond.

Acquisition may include acquiring matters input by a user or the like, or may include acquiring information stored in another device. Acquiring information stored in the other device may include acquiring information stored in the other device via API or the like, or may include acquiring the contents of document files (including the contents of web pages) provided by the other device. Further, it may include acquiring information in a format different from the original information based on the original information, such as acquiring information by performing optical character reading for the image file.

Further, a so-called machine learning method may be used to acquire information. For example, the use of machine learning methods can be done as follows. That is, a learner (learning information) with a specific type of input information as input and output information of the type to be acquired as output is created using a machine learning method. For example, two or more sets of input information and output information are prepared in advance, the two or more sets of information are given to a module for creating a machine learning learner to create a learner, and the created learner is stored in the storage unit. The learner can also be called a classifier. The machine learning method may be, for example, deep learning, random forest, SVM, or the like. Machine learning may also use functions in various machine learning frameworks such as fast Text, tinySVM, random forest, TensorFlow, and various existing libraries. Acquiring information using such a learner is sometimes called acquisition by machine learning.

Further, the learner is not necessarily limited to ones obtained by machine learning. The learner may be, for example, a table showing a correspondence between an input vector based on input information and the like and output information. In this case, output information corresponding to a feature vector based on input information may be acquired from a table. Alternatively, a vector approximating to a feature vector based on input information may be generated using two or more input vectors in the table and a parameter for weighting each input vector may be generated. Then, a final output information may be acquired using the output information corresponding to each input vector used for generation and parameters. Acquiring information using such a learner may be sometimes called acquisition using correspondence. Further, the learner may be, for example, a function representing the relationship between an input vector based on input information or the like and information for generating output information. In this case, for example, information corresponding to the feature vector based on the input information may be calculated by a function, and output information may be acquired using the obtained information. Acquiring information using such a learner may be sometimes called acquisition using a function.

Information output is a concept that includes displaying on a display, projecting using a projector, printing with a printer, sound output, transmission to an external device, storage on a storage medium, delivery of processing results to other processing devices or other programs, and the like. Specifically, for example, enabling images of information on a web page, sending the information as an e-mail or the like, and outputting the information for printing, and the like may be included.

Acceptance of information is a concept that includes acceptance of information input from an input device such as a keyboard, a mice, a touch panel, etc., the reception of information transmitted from another device via a wired or wireless communication line, and the acceptance of information read from a storage medium such as an optical disk, magnetic disk, semiconductor memory, etc.

For various types of information stored in an information processing device or the like, updating is a concept that includes not only changing the stored information, but also adding new information to the stored information, or erasing part or all of the stored information.

### EMBODIMENT

The overview of the present embodiment is as follows. The restaurant system according to the present embodiment is configured to provide an item to a seat used by a visitor in a store, and is configured to convey the item by a conveying device with a container housing the item. The restaurant system includes a change detection unit that detects a change in the state of the container and an alert unit that outputs alert information indicating that an abnormality related to the container may have occurred based on the detection result of the change detection unit.

The change detection unit is preferably configured to detect, for example, information on the state of a container conveyed to a seat and information on the state of a container conveyed from the seat. Further, the change detection unit detects an open/close state of the container, and it is preferable to output alert information when the container is changed to a closed state from an open state. The change detection unit may detect information such as presence or absence (i.e., existence) of an item in the container based on an image of a camera that is configured to capture the inside of the container when the container is the open state. In this case, for example, when a state change from a state in which there is no item to a state in which the item is present is detected, alert information may be output. Further, the change detection unit may detect a change in the state of the container based on captured images by a camera that is configured to capture the container in the process of being conveyed to a seat or based on a detection result of an open/close detection unit that is disposed in the container.

The alert unit may output the alert information in a notification mode corresponding to a container identifier that is used to identify the corresponding container. For example, the alert information specifying a container may be output, or the alert information may be output to an output destination corresponding to the container.

Hereinafter, one example of a restaurant system, an information processing device used therein, and the like will be described.

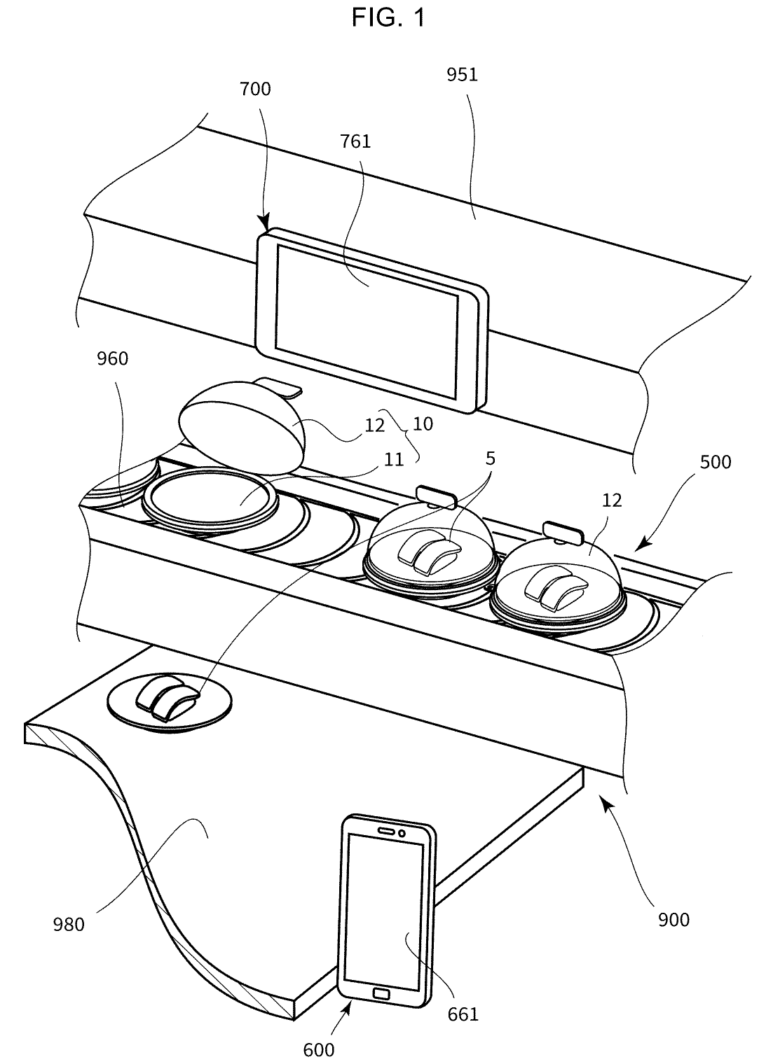

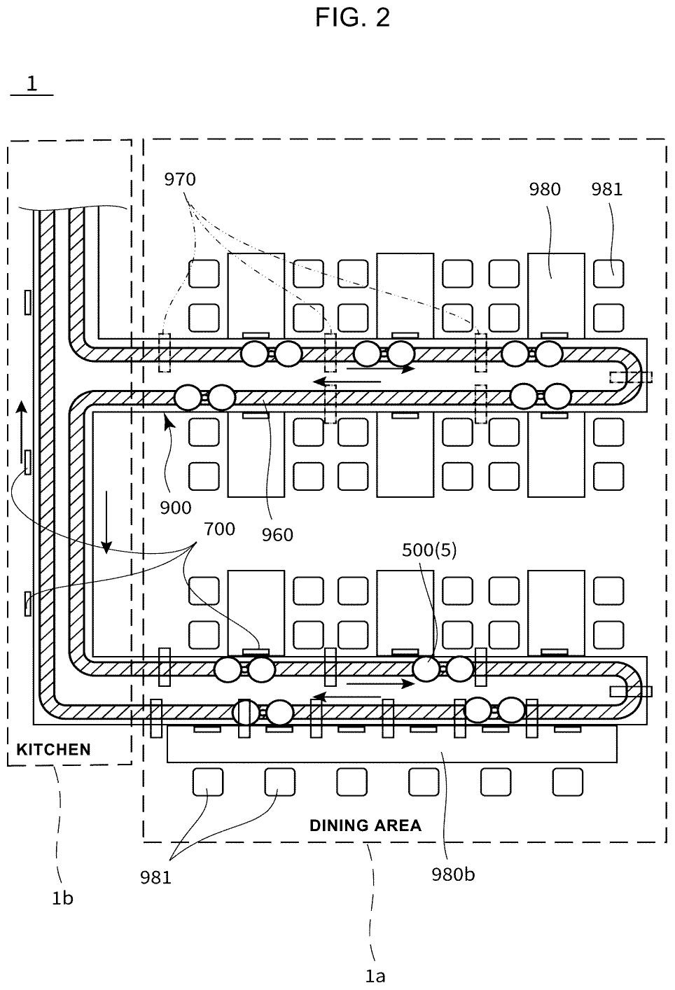

FIG. 1 is a diagram illustrating an example of a conveying device 900 in a restaurant in which the restaurant system 1 in the present embodiment is installed. FIG. 2 is a plan view showing an example of the conveying device 900.

The restaurant system 1 according to the present embodiment is used in a building such as a restaurant or a store, for example. FIG. 1 shows a part of fixtures and the like. FIG. 2 shows an example of the conveying device 900 in a building such as a restaurant. The restaurant may be, for example, a so-called conveyor belt sushi restaurant. The building in which the restaurant system 1 is used may be a restaurant of another field or business type or a building that is not a restaurant. In addition, an item served to a user may be a free item or a paid item.

In the present embodiment, the item is a food, a beverage, or a drink such as sushi, for example. For example, the item may be a dish such as nigiri sushi, hand-rolled sushi, or other plates. Further, the food and the drink may include a beverage, a confectionery, a containerized food, a packaged food, and the like. Further, the item may be any other item having value than foods and drinks such as a gift or goods.

In the present embodiment, the restaurant system 1 allows a user who is a visitor to place an order for an item at each seat. Further, in the restaurant system 1, the item may be conveyed to a user by the conveying device 900.

Here, “seat” is a concept meaning a seat or table used by a user (a customer) to whom the item is served. One seat corresponds to, for example, a customer group of one or more users who purchase an item (the customer group may include one or more users and may be a single user). For example, when a customer group formed of a plurality of users comes to a restaurant, and the customer group is guided to one table in the store, the one table corresponds to a seat. Further, for example, when a customer group with only one person comes to a restaurant, and the customer group is guided to one counter seat in the restaurant, the one counter seat corresponds to a seat. However, the seat is not necessarily limited to an actual seat or table. The seat may be other things indicating a purchaser, an ordering person/entity, a provider, or the like for the item as corresponding to a group formed of one or more users. Such a seat may be real or virtual. In other words, the “seat” is a concept that indicates a unit to which the item is provided and the price of the item is charged. In the following description, a seat corresponding to such a user (the customer group) may simply be referred to as a user. That is, when an item is provided to a seat corresponding to a user (a customer group), it may be simply expressed as “an item is provided to a user”.

The restaurant system 1 includes the conveying device 900, the information processing device 100, and a notification device 700. The notification device 700 is, for example, a reception terminal disposed at each seat. However, one notification device 700 may be shared with two or more seats. Further, two or more notification devices 700 may be used at one seat. Further, the notification device 700 may be disposed in a kitchen 1b described later so that staffs of the restaurant can use the notification device 700.

Further, in the present embodiment, it may be interpreted that the restaurant system 1 has a terminal device 600 capable of communicating with the information processing device 100 via a network, for example. The terminal device 600 is, for example, used by a user. That is, customers of a restaurant receive services from the restaurant system 1 using terminal devices 600 or the like.

In the present embodiment, one customer group can order items or the like using the notification device 700 that is disposed at the seat for the group. The notification device 700 has a notification display device 761 that is a screen such as a touch panel. Note that the customer group may also order items using one or more terminal devices 600 owned by the group. In this case, for example, a configuration of the restaurant system as described in JP2021-015529A, which is incorporated herein by reference, may be used.

In FIG. 1, for example, a portable information terminal device such as a so-called smartphone is shown as the terminal device 600. The terminal device 600 includes a terminal display device 661 that is a screen such as a touch panel. Alternatively, a personal computer (PC) such as a tablet-type information terminal device and a laptop computer may be used as the terminal device 600. Furthermore, although a tablet-type information terminal device is used as the notification device 700, a portable information terminal device, a personal computer (PC), or the like may also be used as the notification device 700.

The terminal device 600 may be used by, for example, a restaurant employee such as a hall staff. That is, the restaurant staff can use the restaurant system 1 using the terminal device 600. For example, a restaurant staff may be able to accept an order by transmitting information such as order details from each seat to the information processing device 100 or the like using the terminal device 600.

In the restaurant system 1, devices can communicate with each other via a network such as, for example, a local area network or the Internet, but are not necessarily limited thereto. The number of the devices in the restaurant system 1 may not be limited, and other devices may be used in the restaurant system 1.

The conveying device 900 is provided between a dining area 1a for users to eat and drink and the kitchen 1b. In the dining area 1a, for example, tables 980 and seats 981 are provided for users to eat and drink. As a table 980, a counter table 980b at which users in a row can eat and drink may be used.

The conveying device 900 includes a conveying path 960 on which plates are conveyed. An item 5 such as sushi is placed on the plate. The conveying path 960 is laid in the dining area 1a so that plates are conveyed along the tables 980. The conveying path 960 is formed using, for example, a crescent chain having a flat upper surface, but is not limited thereto. The conveying path 960 is configured to convey the plates in a predetermined conveying direction (indicated by an arrow in FIG. 2) and to circulate the plates between the kitchen 1b and the dining area 1a. That is, the conveying path 960 conveys plates with sushi or the like, which is an item 5, from the upstream side to the downstream side. When viewed from a certain point on the conveying path 960, the upstream is a side where the item 5 is approaching, and the downstream is a side where the item 5 is moving away.

In the conveying device 900, an upper unit 951 is disposed above the conveying path 960. The upper unit 951 is provided with a lighting device, and is configured to emit light downward to illuminate the conveying path 960. The notification device 700 is disposed in the upper unit 951. In the restaurant system 1, using a so-called electronic menu displayed by the notification device 700, a user at a seat can place an order for the item 5 or the like. For such a configuration for accepting an order for the item 5, a publicly-known method can be used, for example. For example, the information processing device 100 accepts an order from each seat based on a user's order operation onto the notification device 700 or the like at the seat, and transmits the contents of the order to a terminal or the like provided in the kitchen 1b (not shown).

In the present embodiment, the notification device 700 and the terminal device 600 receive information output (transmitted) from the information processing device 100, and based on the received information, the notification display device 761 and/or the terminal display device 661 display information or the like. The notification device 700 and the terminal device 600 display information or the like based on alert information when the alert information is input into the notification device 700 and the terminal device 600. Note that the notification device 700 and the terminal device 600 are capable of outputting audio sound, light, and the like, and may output audio sound, light, or the like based on the output alert information.

Here, in the present embodiment, the item 5 is provided to a user using a container 10. The container 10 is placed on the conveying path 960. The container 10 includes a base 11 on which a plate with an item 5 is placed and a cover 12 that is a lid configured to cover an upper surface of the base 11. The plate on which the item 5 is placed is conveyed on the conveying path 960 while being covered by the cover 12 of the container 10. By opening the cover 12 of the container 10, each user can pick up the conveyed item 5 together with the plate and move the item 5 to the table 980 for eating. The container 10 from which the item 5 was removed remains in the open state with the cover 12 being opened and is conveyed to the kitchen 1b by the conveying path 960. The container 10 may be referred to as an item container, a food/beverage container, an item cover, or the like.

As a container 10, the container described in JP 5722842 B2, which is incorporated herein by reference, may be used. In the present embodiment, two items 5 may be conveyed together by the conveying path 960 as a connecting body 500 in which the two containers 10 are connected to each other. However, a providing method is not necessarily limited to this.

In the present embodiment, the restaurant system 1 includes inter-seats detection units 970 for detecting the container 10 being conveyed on the conveying path. In the present embodiment, by using the inter-seats detection unit 970, the container 10 can be detected, thereby the inter-seats detection unit 970 can detect information related to the item 5. However, the sensor 970 may detect information only on the container 10.

A plurality of inter-seats detection units 970 may be arranged, for example, along the conveying path 960, and include a sensor element for detecting information related to the container 10. The sensor element may be, for example, a camera that acquires an image, a contact sensor, a non-contact sensor such as a photoelectric sensor or a proximity sensor, or a reader capable of reading an RF tag (IC tag), but is not limited thereto, and two or more sensors among them may be used together. The sensor element or the like may be a sensor such as LiDAR capable of acquiring a distance image. The inter-seats detection unit 970 may work using a sensor element disposed on the conveying path 960 together with the information processing device 100 or another device such as a computer. The inter-seats detection unit 970 may process information obtained by the sensor element without cooperating with the information processing device 100 and then output the processed information to the information processing device 100.

The inter-seats detection unit 970 is configured to detect each of the two or more containers 10 being conveyed on the conveying path 960 to acquire information related to the containers 10. In the present embodiment, the inter-seats detection unit 970 is disposed at a position between the adjacent seats (between the tables 980, between the seats 981 of the counter table 980b). It may be said that the inter-seats detection unit 970 is disposed for each seat at at least one end of the seat. It can be said that the conveying path 960 is divided into a plurality of sections, each of which corresponds to a respective seat, and the inter-seats detection unit 970 is disposed to detect the container 10 at a position close to the boundary of the adjacent sections.

In the present embodiment, the inter-seats detection unit 970 is disposed to detect, based on a detection result by the sensor element of the inter-seats detection unit 970, a state of opening or closing of the cover 12 of the container 10 that has arrived at the boundary point between the adjacent seats. That is, the inter-seats detection unit 970 detects a section (an area) among a plurality of sections corresponding to the seat in the conveying path 960 where the container 10 is opened. Normally, the container 10 in the open state means that the item 5 has been picked up from the conveying path 960. Therefore, as will be described later, the customer on the seat is charged with a price for the item according to the open/close state of the container 10.

In the present embodiment, the inter-seats detection unit 970 captures the images of the conveying path 960 by a camera. That is, in the restaurant system 1, the open/close state of the container 10 that has arrived at the point between the seats can be detected based on the images captured by the inter-seats detection unit 970. For example, it is possible to detect whether the cover 12 of the container 10 is opened or closed. Two or more cameras may be used for each of the inter-seats detection units 970 to capture images in one range. Detecting the open/close state using the images may be performed by acquiring information indicating whether the cover 12 is opened or closed output from a machine learning learner or by performing other publicly-known image recognition technology. Further, in the present embodiment, the restaurant system 1 may acquire an attribute value related to the type of the item 5 and the like based on images of the container 10 captured by the inter-seats detection unit 970. In this case, for example, a two-dimensional code forming an identifier is attached to the container 10, and the reading result of the two-dimensional code may be used to detect information related to the item 5.

Detection using images captured by the inter-seats detection unit 970 may be performed by the inter-seats detection unit 970. In this case, the detection result by the inter-seats detection unit 970 is output to the information processing device 100 or the like. Further, detection using the images captured by the inter-seats detection unit 970 may be performed by the processing unit 140 of the information processing device 100, which will be described later. In this case, the images captured by the inter-seats detection unit 970 and the information created based on the images are output from the inter-seats detection unit 970 to the information processing device 100.

The inter-seats detection unit 970 may include at least one camera that captures images of an inside of the container 10. In the present embodiment, the inter-seats detection unit 970 includes a camera that captures the inside of the container 10 when the cover of the container 10 is opened. Then, as will be described later, the restaurant system 1 uses images acquired by capturing the conveying path 960 with the camera of the inter-seats detection unit 970. Such a detection may be performed by acquiring information indicating whether the cover 12 is opened or closed output from a machine learning learner or by performing other publicly-known image recognition technology. As described above, such a detection process may also be performed by the inter-seats detection unit 970 itself, or may be performed by the information processing device 100 or the like.

Note that the inter-seats detection units 970 are not limited to those using a camera. For example, the inter-seats detection unit 970 may use an open/close detector and a reader as described in JP5722842B, which is incorporated herein by reference. In this case, for example, an RF tag unique to the container 10 is provided, and information read by the reader can be used as information related to the identification of each item 5. Further, a state related to the opening and closing of the container 10 may be detected using the open/close detector.

In addition, detection of the item 5 may be performed by detecting the container 10 using the detection result of the inter-seats detection unit 970. This may be done, for example, using information in which an identifier for each container 10 is associated with information on the item 5 housed in the container 10. As the information related to the item 5, information related to the identification of the item 5, information related to the state of the item 5, and the like may be acquired.

Information related to the identification of the item 5 is, for example, an attribute value for identifying each item 5 and an attribute value for specifying a type of the item 5 (such as a menu name or a category to which the item 5 belongs). Examples of such attribute values include an identifier for identifying each plate or each container 10 housing the item 5, an identification result of a serving manner when the item 5 is served in a particular manner, and information based on an image of the item 5 (the information may be the image itself, or may be a feature quantity that is acquired from the image). That is, detecting information related to the item 5 may be identifying information related to item 5.

Information related to the state of the item 5 is, for example, information indicating the state of the item 5 and information used to recognize the state of the item 5. The state of the item 5 is, for example, the position of the item 5, the presence or absence of the item 5, the elapsed time since the item 5 was set on the conveying path 960, and the like, but is not necessarily limited them.

The position of the item 5 may be, for example, a relative position on the conveying path 960, or the absolute position of the item 5 in the restaurant, that is, the position of the item 5 with respect to each user. When the relative position on the conveying path 960 (the position of the item 5 from the starting point on the conveying path 960) can be acquired, the relative position may be detected as information used to detect the state of the item 5. That is, based on the relative position and the position of the conveying path 960, it is possible to acquire the absolute position of the item 5. The position of the item 5 here may be described as the position of the container 10.

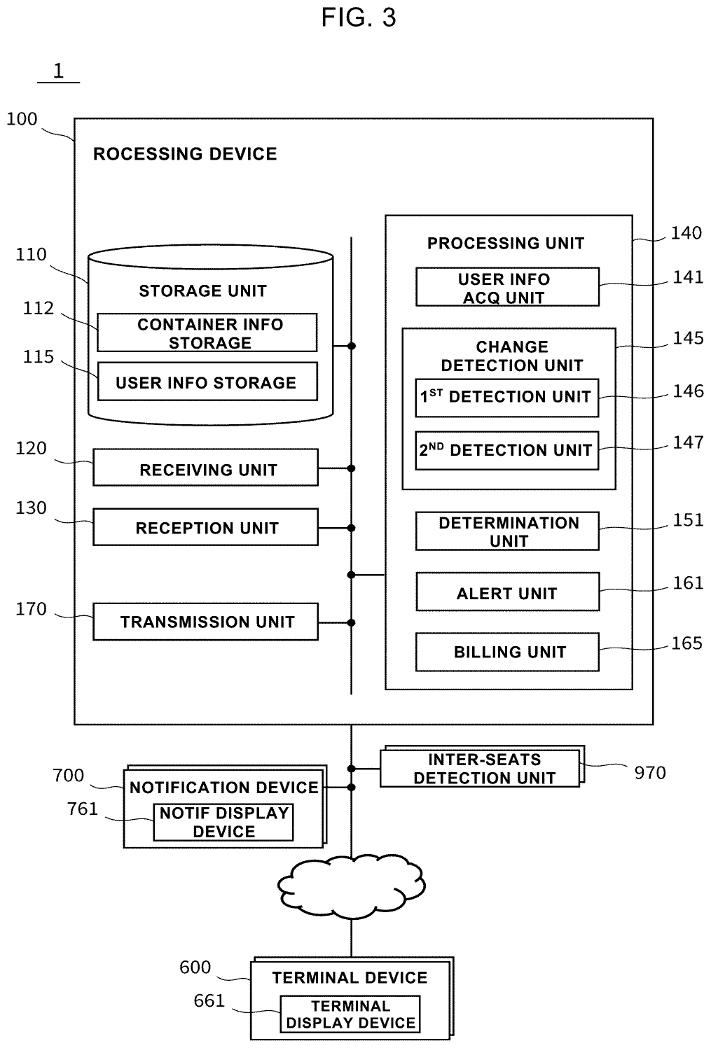

FIG. 3 is a block diagram of the restaurant system 1.

As shown in the figure, the information processing device 100 includes a storage unit 110, a receiving unit 120, a reception unit 130, a processing unit 140, and a transmission unit 170.

The storage unit 110 includes a container information storage unit 112 and a user information storage unit 115.

The storage unit 110 may be preferably a non-volatile storage medium, but may also be a volatile storage medium. A plurality of pieces of information acquired by each device and the like are stored in the storages 112,115, but the process of storing information and the like is not necessarily limited to this. For example, information or the like may be stored via a storage medium, information transmitted via a communication line or the like may be stored, or information input via an input device may be stored.

The container information storage unit 112 stores, for example, a detection result on the state of the container 10 by the inter-seats detection unit 970. In the following description, the detection result may be referred to as “container information”.

In the present embodiment, the container information may be various attribute values related to a container 10. For example, the various attribute values may be a container identifier for identifying each container 10, information detected by the inter-seats detection unit 970 on the state of the container 10, and the like. Examples of the detected information include, for example, information indicating whether the cover 12 of the container 10 is in the open state or the closed state, information indicating whether the item 5 exists in the container 10, information indicating whether foreign matter exists, and the like, but is not necessarily limited thereto. The container information may be, for example, information acquired based on the information detected by the inter-seats detection unit 970 on the state of the container 10. That is, the state of the container 10 is detected by the inter-seats detection unit 970, and information such as the determination result of an alert condition and a charging condition, which will be described later, acquired based on the detection result of the state may be included.

The user information storage unit 115 stores user information related to a user who uses the restaurant system 1. In the present embodiment, the user information is information in which a user identifier, which is an identifier for identifying a user who uses the restaurant system 1, is associated with information related to the user. The user information may include various information. For example, the user information is stored in the user information storage unit 115 by being received by the receiving unit 120, by being received by the reception unit 130, or by being acquired as a result of information processing executed by the processing unit 140.

In the present embodiment, the user information may be information related to a seat for the user. That is, in the present embodiment, the user information based on information transmitted from a terminal operable by the user, such as the terminal device 600 and the notification device 700, may be stored in association with seat specifying information such as a seat identifier for specifying a seat and a terminal identifier for identifying the terminal device 600. In addition, the user information may include a predetermined attribute value related to the state in which the user visited the restaurant. The predetermined attribute value may be, for example, information such as the number of people in the customer group who are users, the time of visit (may be the elapsed time since the customer group visited the restaurant), etc., but is not necessarily limited thereto. Information such as the number of adults and children in the customer group may be also included. Further, an identifier or the like may be included for identifying a restaurant staff in charge of various serving operations for the seat used by the user.

Further, the user information may include, for example, information on the order history of the items 5. For example, order information indicating an ordering status for each seat and consumption information indicating a consumption status of the items 5 for each seat may be included as the user information.

The order information is, for example, information related to the order of an item, and information including seat specifying information for specifying a seat. The order information has, for example, an item identifier for uniquely identifying the item. The order information includes, for example, an item identifier and the number of orders. The order information may include, for example, the item identifier and a price. The order information may be, for example, information indicating that a plate on which the item 5 is placed was served (provided) to the customer group. In other words, the order information may include information subsequent to the order.

The consumption information is information related to the amount or quantity of the items 5 consumed by a user. In the present embodiment, the consumption information is, for example, the price of an item 5 consumed by the user, but is not necessarily limited thereto. The number of items 5 consumed by the user may be used as consumption information. In the present embodiment, the item 5 is placed on a plate each predetermined unit and served to the user. In this case, the number of plates of the items 5 consumed by the user may be used as the consumption information.

In addition, as information related to the order history such as the order information and the consumption information, information related to the order history at the user's current opportunity (i.e., the order history at this time) may be included in the user information. Based on such information on the order history, the user can be charged for the use of the restaurant. Such information on the order history may be stored, for example, for each user belonging to a customer group.

The receiving unit 120 receives information transmitted from other devices. The receiving unit 120 may be wireless or wired communication means, but may be means of receiving a broadcast.

The receiving unit 120 stores the received information in the storage unit 110, for example. In the present embodiment, the user can input information using the terminal device 600 and transmit the information to the information processing device 100, for example. The receiving unit 120 stores each transmitted information in the storage unit 110 by associating the information with the terminal identifier or the seat identifier. In the present embodiment, the receiving unit 120 receives order information transmitted from each terminal device 600 and the notification device 700, associates the information with the terminal identifier or the seat identifier, and stores the information in the storage unit 110. When receiving information from the notification device 700, the receiving unit 120 specifies, based on the transmitted information, the seat identifier for specifying a seat corresponding to the notification device 700. Further, when the receiving unit 120 receives information from the terminal device 600, the receiving unit 120 specifies the terminal identifier based on the transmitted information.

The reception unit 130 accepts information input via input means (not illustrated) connected to the information processing device 100. The reception unit 130 stores the received information in the storage unit 110, for example. The input means may be anything, such as a numeric keypad, a keyboard, a mouse, or a menu screen. The reception unit 130 may be a device driver for input means such as a numeric keypad or a keyboard, control software for a menu screen, or the like. The reception unit 130 may receive information input by an input operation using a reading device (for example, a code reader, etc.) connected to the information processing device 100. The information may include, e.g., information read by the reading device.

In other words, the reception unit 130 accepts the information received by the receiving unit 120 as information input into the information processing device 100. That is, the input of information into the information processing device 100 may be interpreted that this information is indirectly input into the information processing device 100 by the user via the notification device 700, the terminal device 600, or the like.

Note that the receiving unit 120 and the reception unit 130 may also receive and accept information transmitted or input by a restaurant staff.

The processing unit 140 performs various processes. Various processes include, for example, processes performed by each portion of the processing unit 140 as described below. The processing unit 140 may include an MPU, a memory, or the like. The processing by the processing unit 140 is usually realized by software, and the software is stored on a storage medium such as ROM. However, the processing may be also realized by hardware (e.g., by a dedicated circuit).

In the present embodiment, the processing unit 140 is configured to output alert information indicating that an abnormality related to the container 10 may have occurred upon determining that the predetermined alert condition is met according to the detection result of a change in the state of the container 10 that is conveyed on the conveying path 960. Such an alert function is realized by a user information acquisition unit 141, a change detection unit 145, a determination unit 151, and an alert unit 161 in the processing unit 140. Further, the processing unit 140 has a billing unit 165. Each component of the processing unit 140 may perform the following processing.

The user information acquisition unit 141 acquires user information that is information on a user who uses the restaurant, that is, a target user. For example, when outputting the alert information described later and charging, etc., the user information acquisition unit 141 acquires user information corresponding to an identifier for identifying the target user or seat from the user information storage unit 115. By acquiring the user information, it is possible to specify the terminal device 600 or the notification device 700 corresponding to the user or the seat.

An example of the user information used in the present embodiment is as follows.

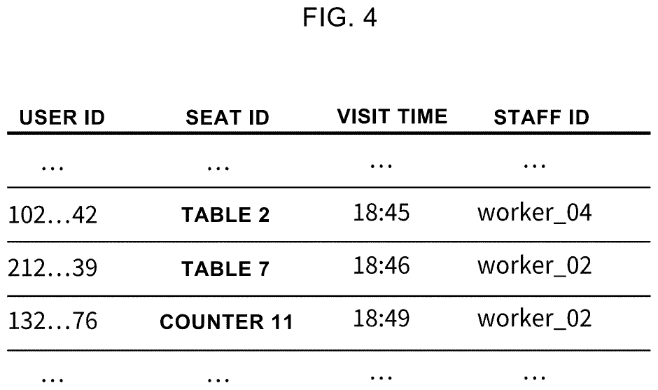

FIG. 4 is a diagram illustrating an example of the user information used by the information processing device 100.

In the example shown in the figure, as the user information, for example, attribute values such as the seat specifying information, a visit time, a staff in charge of serving for the seat used by the user, and the like are stored in association with a user identifier (user ID) for specifying the user information. For example, the seat identification information may include a seat identifier such as a table number from which the table 980 used by the user can be identified and a seat number from which the seat 981 of the user using the counter table 980b can be identified.

When the user information includes an identifier related to a staff in charge for the seat, the terminal device 600 or the like used by the user or the staff for the seat may be specified based on the user information on each user.

Note that the user information may include information other than the above-described information, or any information (for example, a staff identifier, etc.) may be stored as information different from the user information. That is, the information stored in the storage unit 110 or the like that can be associated with the user identifier or the seat identifier, or information that can be acquired in association with the user identifier or the seat identifier, may be recognized as the user information.

Returning to FIG. 3, the change detection unit 145 is configured to detect, for each seat, a state change in the container 10 that is being conveyed by the conveying device 900. In the present embodiment, the change detection unit 145 can detect a change in the state of the container 10 conveyed within a range for the corresponding seat in the restaurant. The change detection unit 145 is configured to specify a container identifier from which the container 10, as a detection target, can be identified. Information used to detect each container 10 (for example, the detection result of the inter-seats detection unit 970 as described later) and the detection result of a state change are, for example, stored in the container information storage unit 112 in association with the container identifier of the container 10, but not necessarily limited to this.

In the present embodiment, the change detection unit 145 is configured to detect a change in the state of the container 10 based on the detection result of the inter-seats detection unit 970. That is, the change detection unit 145 is configured to detect a change in the state of each container 10 that has passed through a section of the conveying path 960 corresponding to the seat according to the detection result by the inter-seats detection units 970 at an upstream point and a downstream point of the section (hereinafter, referred to as a “corresponding section”).

When focusing on one seat, such a change in the open/close state may be detected by the change detection unit 145 as follows. That is, in the present embodiment, the change detection unit 145 has a first detection unit 146 and a second detection unit 147, and the change in the state of the container 10 may be detected based on the detection result of the first detection unit 146 and the detection result of the second detection unit 147. Here, the first detection unit 146 detects information on the state of the container 10 conveyed to a seat based on the detection result of the inter-seats detection unit 970 located on an upstream side of the seat (for convenience, the sensor 970 may be referred to as a first inter-seats detection unit 970). The second detection unit 147 detects information on the state of the container 10 conveyed from the seat based on the detection result of the inter-seats detection unit 970 located on a downstream side of the seat (for convenience, the sensor 970 may be referred to as a second inter-seats detection unit 970). The first inter-seats detection unit 970 is located at a position of the boundary between a corresponding seat and an upstream-side seat, and the second inter-seats detection unit 970 is located at a position of the boundary between the corresponding seat and a downstream-side seat. In the configuration of the restaurant system 1, the first detection unit 146 may include the first inter-seats detection unit 970, and the second detection unit 147 may include the second inter-seats detection unit 970.

In the present embodiment, the change detection unit 145 detects, for example, a change in the open/close state of the cover 12 of the container 10 (one example of a “state change”). That is, the change detection unit 145 is configured to detect a change in the open/close state of the cover 12 of each container 10 that has passed through the corresponding section of the conveying path 960 according to the detection result by the inter-seats detection units 970 at an upstream point and a downstream point of the section. In other words, the first detection unit 146 and the second detection unit 147 are configured to detect the open/close state of the cover 12 of the container 10, whereby the change detection unit 145 can detect a change in the open/close state of the cover 12. The first detection unit 146 and the second detection unit 147 may be configured to detect the open/close state based on the detection result by the sensor element of the inter-seats detection unit 970, or the first detection unit 146 and the second detection unit 147 may be configured to acquire the detection result of the open/close state by the inter-seats detection units 970. Even in the latter case, it can be described that the first detection unit 146 and the second detection unit 147 detect the open/close state.

Further, the change detection unit 145 detects, for example, a change in the state (one example of the “state change”) of the presence or absence of the item 5 in the container 10. Such detection can be performed using an image captured by the camera of the inter-seats detection unit 970 that captures the inside of the container 10. That is, the change detection unit 145 acquires an image in the container 10 by the camera of the inter-seats detection units 970 on the upstream side and the downstream side of the corresponding section for one seat. Then, according to the image, a change in the state related to the presence or absence of the item 5 in each container 10 that has passed through the corresponding section may be detected. In other words, the first detection unit 146 and the second detection unit 147 may detect the state related to the presence or absence of the item 5 in the container 10 based on the image of the inside the container 10 captured by the camera. The first detection unit 146 and the second detection unit 147 may detect the state related to the presence or absence of the item 5 based on the image captured by the seat detection unit 970, or the first detection unit 146 and the second detection unit 147 may acquire the detection result of the state related to the presence or absence of the item 5 by each of the inter-seats detection units 970. Even in the latter case, it can be described that the first detection unit 146 and the second detection unit 147 detect a state related to the presence or absence of the item 5.

In the present embodiment, based on the image of the container 12 captured by the change detection unit 145 with the cover 12 being open, the first detection unit 146 and the second detection unit 147 may detect the state related to the presence or absence of the item 5. Thereby, it is possible to easily and reliably detect a state related to the presence or absence of the item 5 (i.e., the existence of the item 5 in the container 10). However, even when the cover 12 of the container 10 is closed, the state related to the presence or absence of the item 5 may be detected based on the captured image. For example, when the cover 12 is made of a translucent material, the state related to the presence or absence of the item 5 may be detected based on an image of the container 10 even with the cover 12 being closed.

In addition, the first detection unit 146 and the second detection unit 147 may be configured to detect, in addition to (or in place of) the state related to the existence of the container 10, other information related to the container 10 based on the image captured by the camera of the inter-seats detection unit 970 that is configured to capture the inside of the container 10. Such other information includes, but is not necessarily limited to, information indicating the presence or absence of an object (may be a foreign substance) that is not the item 5, information on the state of item 5 (whether it is a normal state or an abnormal state), and the like. That is, the first detection unit 146 and the second detection unit 147 may be configured to detect some information regarding the state of the container 10 using an image captured by the camera of the inter-seats detection unit 970 capable of photographing the inside of the container 10. In this case, it can be described that the change detection unit 147 detects a change in the state of the container 10 based on the detection result.

Note that only the plate may be detected as an item 5, or may be detected as a foreign substance, for example. In the case where the item 5 is usually placed on a plate, the plate and the object placed thereon altogether may be detected as the item 5, or the plate and the object placed thereon may be distinguishably detected.

The determination unit 151 determines whether a predetermined alert condition is met based on the detection result of the change detection unit 145. It can be described that the alert condition includes a condition related to a change in the state of the container 10. The alert condition may be one condition or may be regarded as a combination of multiple conditions.

In the present embodiment, determination regarding the alert condition is performed for each seat. Further, determination regarding the alert condition is performed for each container 10. That is, the determination unit 151 determines whether the alert condition is met for each container 10 that passes through the corresponding section for each seat on the conveying path 960. Note that the determination unit 151 may determine whether the alert condition is met for each of two or more seats (for example, for each block in which the restaurant is divided into a plurality of blocks each having certain number of seats).

In the present embodiment, the alert condition may be met when a sign where an abnormality occurs in the container 10 or the item 5 is shown as the state change of the container 10 (hereinafter, a “state change condition”). As such a state change condition, for example, the following conditions are set.

That is, the state change condition is met when, for example, for the open/close state of the cover 12 of the one container 10 conveyed to a seat, the open state is detected by the first detection unit 146, and the closed state is detected by the second detection unit 147. Usually, the state of the container 10 is maintained once the container 10 is opened. When the container 10 is conveyed to the corresponding section in the open state, the container 10 should be conveyed out from the corresponding section in the open state. When the container 10 conveyed to the corresponding section in the open state is turned to be the closed state when the container 10 is conveyed out from the corresponding section, there is a possibility that an abnormality such as the container 10 being operated by someone in the corresponding section to change to the closed state may occur. Therefore, such a condition is set as the state change condition.

Further, the state change condition may be met when, for example, the first detection unit 146 detects that there is no item 5 in the container 10 conveyed to a seat, but the second detection unit 147 detects that the item 5 is present in the container 10. Normally, once the item 5 is taken out from the container 10, another item 5 is not housed in the container 10. If the container 10 conveyed to the corresponding section without an item 5 has the item 5 at the time of exiting the corresponding section, there is a possibility that an abnormality such as the item 5 being returned to the container 10 by someone in the corresponding section may occur. Therefore, such a condition is set as the state change condition.

In addition, when the first detection unit 146 and the second detection unit 147 detect a foreign matter, this situation may be set as the state change condition that a foreign matter that was not present at the time of entering the corresponding section is detected at the time of exiting the corresponding section. Further, when the first detection unit 146 and the second detection unit 147 are configured to distinguishably detect the plate and the presence or absence of the item 5 on the plate, the situation where something that was not present at the time of entering the corresponding section is detected at the time of exiting the corresponding section may be set as the state change condition. Further, when the first detection unit 146 and the second detection unit 147 is configured to detect the state of the item 5 (for example, the position of the item 5, the number of items 5, posture of the item 5, color of the item 5, etc.), the situation where the state is changed between entering the corresponding section and exiting the corresponding section may be set as the state change condition.

Note that a condition different from the state change condition may be included as the alert condition. For example, a condition related to the number of users who are using seats, the time of day, the degree of congestion of the restaurant, the number of staffs, the type of the container 10, and the like may be used. In this case, the alert condition may be met when both such a condition and the state change condition are met.

The alert unit 161 outputs the alert information when the alert condition is determined to be met by the determination unit 151. The alert information is information indicating that an abnormality may have occurred on the container 10. In other words, when a predetermined alert condition is determined to be met based on the detection result of the change detection unit 145, the alert unit 161 outputs the alert information indicating that an abnormality related to the container 10 may have occurred.

Output of the alert information may include, for example, transmitting information for displaying, by another device, an image that an abnormality related to the container 10 may have occurred, outputting information to a display unit or the like in the information processing device 100, and outputting information including an instruction for controlling another device to execute a predetermined operation

In the present embodiment, when the alert unit 161 determines that the alert condition is met by the determination unit 151 as to the container 10 conveyed in the corresponding section for a seat, the alert unit 161 is configured to output the alert information related to the container 10 corresponding to the container identifier in an output mode corresponding to the container identifier specified by the change detection unit 145. Outputting the alert information in an output mode corresponding to the container identifier may include, for example, outputting the alert information having the content displayed according to the alert information to correspond to the container identifier, outputting the alert information using information that can be acquired based on the container identifier, and outputting the alert information in both the above-outputting ways.

Specifically, for example, the alert unit 161 may output the alert information including information corresponding to the container identifier specified by the change detection unit 145 as the alert information related to the container 10 corresponding to the container identifier. For example, the alert information may include information for identifying the container 10 for which the alert condition is determined to be met. The information for identifying the container 10 may be the container identifier itself or information associated with the container identifier (for example, the type of item 5 or information indicating the position of the container 10). As the information indicating the position of the container 10, information related to the seat at which the container 10 arrives now or in future, information for identifying staff in charge of the corresponding seat, and the like may be used. As the information indicating the position of the container 10, information for specifying the seat that is a trigger for the determination that the alert condition was met and information corresponding thereto may be used.

In this way, based on the output of the alert information, it is possible for the information processing device 100 or another device to display or indicate that there may be an abnormality in the container 10 by indicating the number of the container 10, that an abnormality may have occurred in the container 10 in which the item 5 of the specific menu should be housed, that an abnormality may have occurred in the container 10 by indicating the position of the container 10, that an abnormality may have occurred in the container 10 by indicating a staff with a serving area where the container 10 is conveyed, and that an abnormality may have occurred in the table by indicating the table.

Further, for example, the alert unit 161 may output the alert information related to the container 10 corresponding to the container identifier to an output destination corresponding to the container identifier specified by the change detection unit 145. For example, the alert unit 161 may acquire the output destination information based on the container identifier and output the alert information using the output destination information. As the output destination information, for example, information indicating the position of the container 10, output destination information that was associated with the container identifier in advance, and the like may be used. As the information indicating the position of the container 10, information related to the seat at which the container 10 arrives now or in future, information for identifying staff in charge of the corresponding seat, and the like may be used. As the information indicating the position of the container 10, information for specifying the seat that is a trigger for the determination that the alert condition was met and information corresponding thereto may be used.

In this way, for example, the alert information can be output by transmitting the alert information to the notification device 700 or the terminal device 600 that is related to the seat to which the container 10 is conveyed now or in future or by transmitting the alert information to the notification device 700, in the kitchen, corresponding to the container 10. Further, the alert information may be output by transmitting the alert information to the notification device 700 or the terminal device 600 that is related to the seat which is a trigger that the alert condition was determined to be met. In this case, the alert unit 161 may output, as the alert information, information including a content reproving a user for his/her act causing such an abnormality as information indicating that an abnormality related to the container 10 may have occurred.

Note that the container 10 may have an output unit configured to communicate with the information processing device 100 and to output the alert information according to a communication result. As the output unit, for example, an alert lamp indicating the alert information in a predetermined lighting manner or a display unit capable of displaying characters or the like may be used. In such a case, the alert unit 161 may output the alert information using information that is used, as the output destination information associated with the container identifier in advance, for communication with the container 10.

Further, outputting the alert information may include storing occurrence information regarding the fact that the alert condition was met in the storage unit 110 or the like. The occurrence information may be, for example, information such as the fact that the alert condition was met, the determination time of the alert condition, and the like, but is not necessarily limited thereto. In this case, for example, information may be stored in a manner corresponding to the container identifier specified by the change detection unit 145. For example, the container identifier and the occurrence information may be stored in association with each other, or the seat identifier corresponding to the container identifier and the occurrence information may be stored in association with each other.

The billing unit 165 charges the user corresponding to the seat based on the detection result of the change detection unit 145. For example, when a predetermined charging condition is determined to be met from the detection result of the change detection unit 145, the billing unit 165 can charge the user of the corresponding seat. The determination may be performed, for example, by the determination unit 151.

The charging condition may include, for example, a normal charging condition in which charging is made in compensation for the item 5. When the normal charging condition is met, the billing unit 165 charges the seat user for the price of the item 5.

That is, the normal charging condition is met when, for example, for the open/close state of the cover 12 of the one container 10 conveyed to a seat, the closed state is detected by the first detection unit 146, and the open state is detected by the second detection unit 147. When the container 10 conveyed to the corresponding section in the closed state is changed to the open state when exiting the corresponding section, it can be assumed that the item 5 has been taken out from the container 10 by someone in the corresponding section. In this case, other conditions, such as a condition related to the detection result of the presence or absence of an item may be combined. For example, when the closed state is detected by the first detection unit 146 and the open state is detected by the second detection unit 147, and when the second detection unit 147 detects that the item 5 is present, charging may not be performed. When the presence of the item 5 is detected by the second detection unit 147 or when the absence of the item 5 is detected by the second detection unit 147, charging may be performed.

The charging condition may include a special charging condition in which charging is made for an amount not in compensation for the item 5. When the special charging condition is met, the billing unit 165 may charge a predetermined amount, for example, to the user of the seat.

The special charging condition may be, for example, the same as the alert conditions, or one of the alert conditions may be set as the special charging condition. For example, a situation where the open state is detected by the first detection unit 146 and the closed state is detected by the second detection unit 147 may be set as the special charging condition. Further, a situation where the absence of the item 5 is detected by the first detection unit 146 and the presence of the item 5 is detected by the second detection unit 147 may be set as the special charging condition.

By making charging based on such a special charging condition, it is possible to effectively avoid a situation where a visitor or the like causes an abnormality.

The transmission unit 170 transmits information to another device via a network or the like. The transmission unit 170 transmits information to, for example, the notification device 700 and the terminal device 600. In other words, the transmission unit 170 outputs information to, for example, the notification device 700 and the terminal device 600.

Note that the transmission unit 170 may be wireless or wired communication means, but may also be broadcasting means.

In the present embodiment, when the alert unit 161 outputs the alert information, the transmission unit 170 transmits the alert information, for example, to the notification device 700 or terminal device 600 used by the user of the corresponding seat or to the notification device 700 or terminal device 600 used by staffs. Then, the notification device 700 or the terminal device 600 displays an image based on the alert information on the notification display device 761 or the terminal display device 661. Thereby, the user, the staff, and the like recognize the image based on the alert information and take necessary steps.

One example of the recording contents of the detection results regarding the state change of the container 10 used in the present embodiment are as follows.

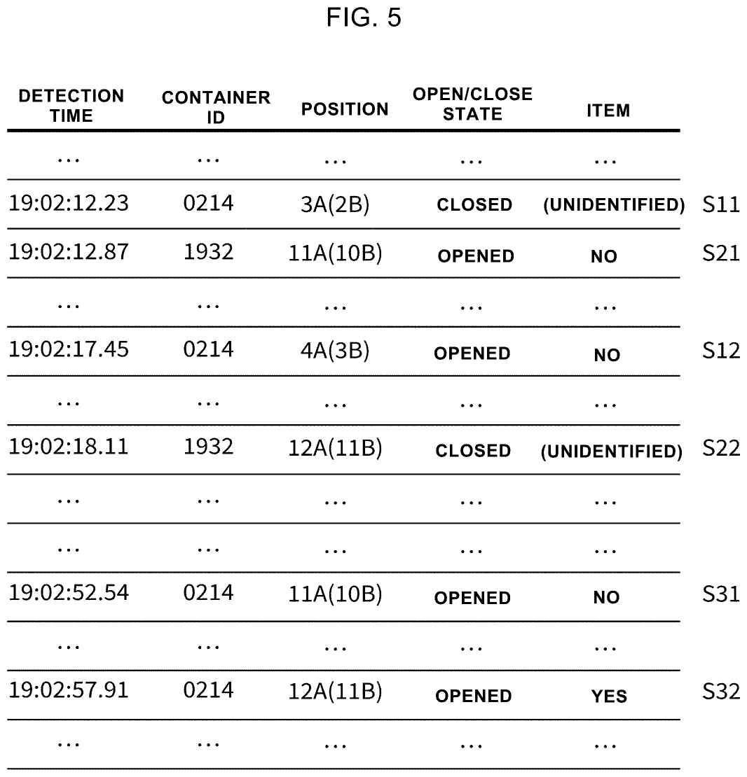

FIG. 5 is a diagram illustrating one example of the detection results related to the state change accumulated by the information processing device 100.

In the example shown in the figure, the recording contents are shown acquired by sequentially recording the detection results regarding the state of the container 10 using the inter-seats detection units 970 as the detection results related to the state change of the container 10. The detection results related to the state of the container 10 may be stored in the container information storage unit 112, for example, in association with the container identifier of the container 10. It can be described that acquiring the detection results regarding the states of the containers 10 using the inter-seats detection units 970 means acquiring detection results regarding the state change of each container 10 for each seat.

That is, in the figure, detection time, information (detection positions) indicative for identifying the inter-seats detection unit 970 used for detection, in other words, indicative of detection positions, information (open/close states) indicative of detection results of the open/close state of the container 10, and information (presence or absence of an item) related to detection results of whether the item 5 is present in the container 10 are stored in association with the container identifier (the container ID). In this example, the presence or absence of an item shall be detected only when the cover 12 is opened. As the detection position, for example, information identifies a seat as a delivery destination for the container 10 which is approaching the detection position, but is not necessarily limited thereto. For example, when the detection position indicates “3A”, this means that the container that was approaching the seat with the seat number 3 was detected at a position close to this seat 3. In other words, the detection position indicating “3A” means that the container that was moving away from the seat with the seat number 2 was detected at a position close to this seat.

One example of the state change in the container 10 detected using such information will be described. Here, for the container 10 with the container identifier “0214”, the container 10 is detected as the closed state when approaching the seat with the seat number 3 (S11) and the container 10 is detected as the open state without an item when moving away from the seat. In this case, it is understood that the item 5 in the container 10 has been taken out from the container 10 at the seat identified by the seat number 3, which is specified by the detection position. As described above, if the normal charging condition is set to be met when the above-described state change is met, charging may be made for the seat.

On the other hand, for the container 10 having the container identifier “1932”, the container 10 is detected as the open state without an item when approaching the seat with the seat number 11 (S21) and the container 10 is detected as the closed state when moving away from the seat (S22). In this case, it is understood that an abnormality may have occurred in the seat identified by the seat number 11 specified by the detection position. When the alert condition is set to be met when the state change is met as described above, the determination unit 151 determines that the alert condition is met. Then, for example, the alert unit 161 outputs the alert information in the output mode corresponding to the container 10.

Further, for the container 10 having the container identifier “0214”, the container 10 is detected as the open state without an item when approaching the seat with the seat number 11 (S31) and the container 10 is detected as the open state with the item when moving away from the seat (S32). In this case, it is understood that an abnormality may have occurred in the seat identified by the seat number 11 specified by the detection position. When the alert condition is set to be met when the state change is met as described above, the determination unit 151 determines that the alert condition is met. Then, for example, the alert unit 161 outputs the alert information in the output mode corresponding to the container 10.

In one aspect of the present embodiment described above, the detection results related to the state change by the change detection unit 145 for a seat can be described, for example, as follows (including those in which the state has not changed). In this case, as an example, the alert condition can be set as follows for each detection result.

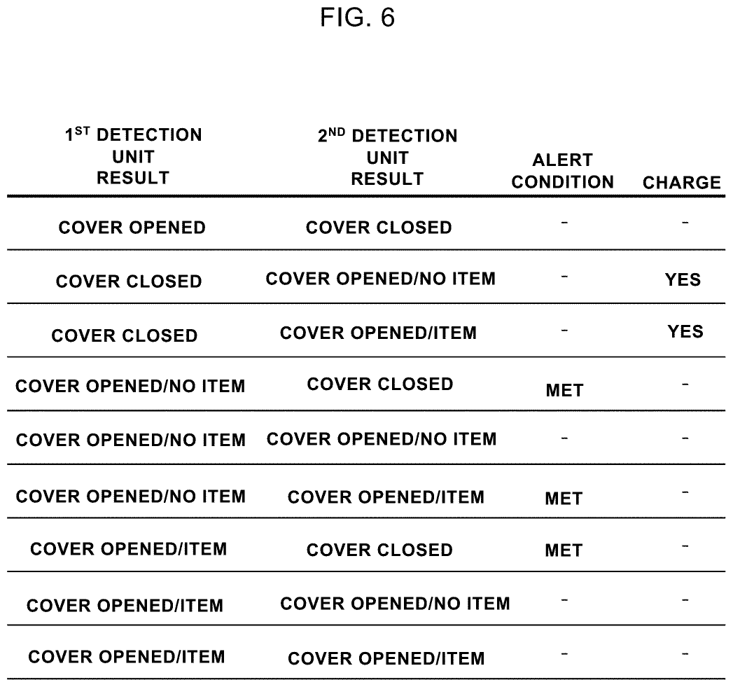

FIG. 6 is a diagram illustrating one example of the alert condition in the information processing device 100.

In the figure, the detection results related to the state change by the change detection unit 145, that is, the combination of the detection results of the first detection unit 146 and the detection results of the second detection unit 147, and in that case, whether the alert condition is met (indicated by “−” if not met) and whether the charging condition is met are shown in a table. Whether the charging condition is met may be described as whether charging is made.

As shown in the figure, the alert condition is met, for example, when (i) the cover 12 is detected by the first detection unit 146 as the open state without an item 5 and the second detection unit 147 detects that the cover 12 as the closed state, (ii) the first detection unit 146 detects that the cover 12 is in the open state without an item 5 and the second detection unit 147 detects that the cover 12 is in the open state with an item 5, or (iii) the first detection unit 146 detects that the cover 12 is in the open state with an item 5 and the second detection unit 147 detects that the cover 12 is in the closed state. That is, in this case, the alert condition is met when the cover 12 in the open state at the time of entering the corresponding section for a seat is changed to the closed state at the time of exiting the corresponding section or when the container 10 without an item 5 at the time of entering the corresponding section for a seat is detected with the item 5 at the time of exiting the corresponding section.

Further, regardless of whether the presence or the absence of the item 5 is detected by the second detection unit 147, charging is made when the first detection unit 146 detects that the cover 12 is in the closed state and the second detection unit 147 detects that the cover 12 is the open state. It is not necessarily limited thereto. For example, charging is made only when the cover 12 changes to the open state and when the absence of the item 5 is detected by the second detection unit 147. Further, if the special charging condition as described above is set, charging may be made when, for example, the alert condition is met.

In the present embodiment, the information processing device 100 provides an alert function by, for example, performing various operations as follows. These operations are performed by the processing unit 140 executing control operations or the like using each of the units.

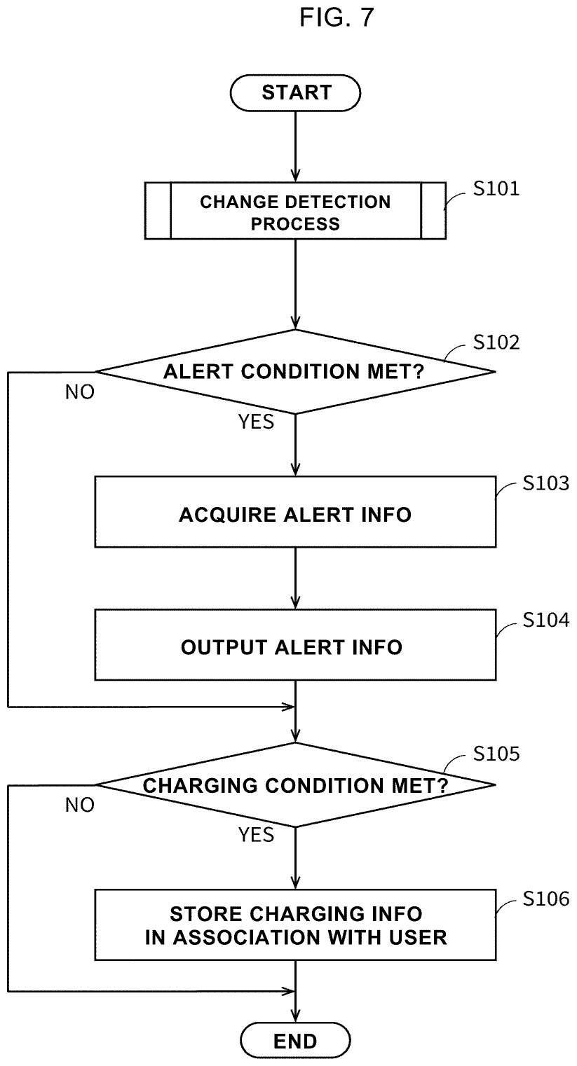

FIG. 7 is a flowchart illustrating one example of the operation by the information processing device 100.

The process shown in the figure is performed, for example, periodically. However, the process may be performed when other predetermined execution conditions are met (for example, a predetermined timing has come, a predetermined information has been detected), or the like.

(Step S101) The processing unit 140 performs a change detection process. The change detection process is, for example, a process as described below.

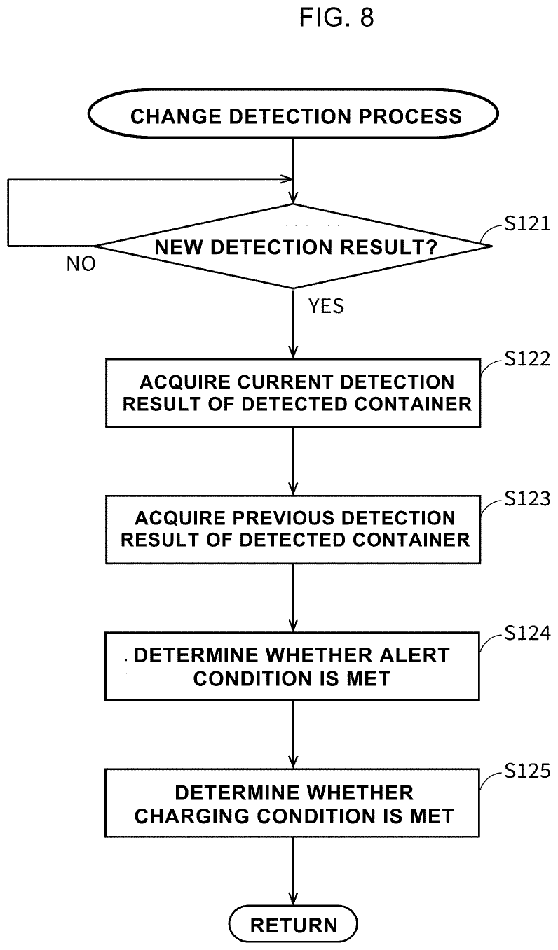

FIG. 8 is a flowchart of one example of the change detection process performed by the information processing device 100.

(Step S121) The processing unit 140 determines whether there is a new detection result by the inter-seats detection unit 970. This process is repeated until the new detection result is determined, and if the new detection result is determined, the process proceeds to the next step.

(Step S122) The processing unit 140 acquires the detection result regarding the newly detected container 10. That is, the detection result using the inter-seats detection unit 970 on the container 10 conveyed away from a seat is acquired. It can be said that the detection is performed by the second detection unit 147 in the above-described description.

(Step S123) The processing unit 140 acquires the previous detection result on the newly detected container 10. That is, for the container 10 conveyed away from the seat, the detection result acquired when the container 10 arrived at the seat is acquired. It can be said that the detection is performed by the first detection unit 146 in the above-described description.

(Step S124) The processing unit 140 determines whether the alert condition is met based on the acquired detection result. The processing unit 140 stores the determination result in the storage unit 110 as a flag associated with, for example, the container identifier of the container 10.

(Step S125) The processing unit 140 determines whether the charging condition is met based on the acquired detection result. The processing unit 140 stores the determination result in the storage unit 110 as a flag associated with the seat identifier or the user identifier corresponding to the inter-seats detection unit 970 that performed the detection. After that, the process returns to the upstream processes.

(Step S102) The processing unit 140 determines whether the alert condition is determined to be met for the detected container 10. The determination is made, for example, according to the presence or absence of the flag stored in the storage unit 110 and the contents, and if the determination is made based on the presence of the flag, the flag is then cleared. This process may be considered to be the same as the process at step S124. If the alert condition is determined to be met, the process proceeds to step S103, and if not, the process proceeds to step S105.

(Step S103) The processing unit 140 acquires the alert information in response to determining that the alert condition is met for the detected container 10. The alert information may be configured according to the container identifier of the detected container 10, for example, as described above.

(Step S104) The processing unit 140 outputs the acquired alert information. The alert information may be output, for example, to an output destination specified according to the container identifier of the detected container 10 as described above.

(Step S105) Next, the processing unit 140 determines whether the charging condition is determined to be met for the detected container 10. The determination is made, for example, according to the presence or absence of the flag stored in the storage unit 110 and the contents, and if the determination is made based on the presence of the flag, the flag is then cleared. Note that this process may be considered to be the same as the process at step S125. If it is determined that the charging condition is met, the process proceeds to step S106, and if not, the series of processes are terminated.

(Step S106) The processing unit 140 makes a charge according to the determination that the charging condition is met. For example, charging may be made by storing charging information including information specifying an amount, the item 5, and the like in association with the seat or the user in the user information storage unit 115. However, the charging method is not necessarily limited to this, and various methods may be used. After that, the series of processes are terminated.

In the present embodiment, when the alert information is output by the alert function, the notification device 700 or the like as the output destination may display, for example, the following notification screen and to perform a notification (alert) based on the alert information. In this example, it is assumed that information for displaying the alert screen is output as the alert information.

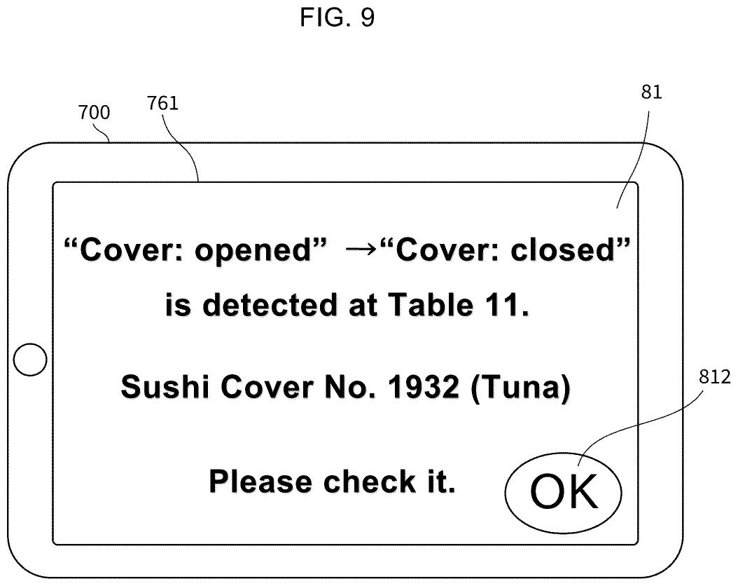

FIG. 9 is a diagram illustrating an example of a screen in which a notification based on the alert information is performed by the notification device 700.

As shown in the figure, in the present embodiment, when a notification based on the alert information is performed by the notification device 700, the alert screen 81 is displayed on the notification display device 761 of the notification device 700. In the example shown in the figure, an example of the alert screen 81 displayed for staffs on the notification device 700 disposed in a backyard such as the kitchen is shown, for example. The alert screen 81 shows, for example, “Cover with opened to closed is detected at Table 11”, to indicate information identifying the seat where the abnormality occurred and information indicating that a predetermined state change that meets the alert condition has been detected. Further, in the present embodiment, the alert screen 81 shows, for example, “Sushi cover No. 1932 (Tuna)” to indicate information related to the detected target container 10 together such that a staff or the like can easily find the specified container 10. In the alert screen 81, a confirmed button 812 is included, and the screen is switched from the alert screen 81 to another screen by operating the confirmed button 812.

By outputting the alert screen 81, a staff or the like who has seen the alert screen 81 can easily recognize that an abnormality may have occurred and confirm the location (the seat) and information for specifying the target container 10.

As described above, in the present embodiment, an alert method using the alert function can be performed in the restaurant system 1. The alert method includes a step of detecting, at a seat, the state change of the container 10 that is being conveyed by the conveying device 900, a step of determining whether a predetermined alert condition is met based on the detection result of the state change, and a step of outputting, to a display device such as the notification device 700 and the terminal device 600, the alert information indicating that an abnormality may have occurred in the container 10 when the alert condition is determined to be met.

With such an alert function, the alert information is output when there is a possibility that an abnormality related to the container 10 has occurred, whereby the user or a staff can be warned of the possibility that the abnormality may have occurred. Further, by notifying the user that the alert function is operating in the restaurant, it is possible to acquire an effect of suppressing users or the like to perform an act that may cause an abnormality related to the container 10.

In the present embodiment, whether there is a possibility that an abnormality related to the container 10 has occurred may be determined using the inter-seats detection units 970 that are also used to charge the user for the item 5. That is, by utilizing the inter-seats detection units 970 for efficiently making charging as an alert function, it is not necessary to use an additional hardware device in the restaurant or the like to realize the alert function, whereby the alert function can be realized at a low cost.

Using the inter-seats detection units 970 arranged between the seats, a change in the state of the container 10 can be reliably detected at each corresponding section. Therefore, it is possible to determine whether the alert condition is met with high accuracy, and the alert information can be reliably output when necessary.

In the present embodiment, the alert information can be output in a manner corresponding to each container 10. Therefore, according to the purpose of outputting the alert information, the alert information can be accurately output and the effect can be obtained. For example, when the alert function is used for staffs to identify the container 10 in which an abnormality may have occurred, the alert information may be output, according to the container identifier of the container 10, the notification device 700 in the kitchen or the terminal device 600 used by a staff or the alert information including information for easily identifying the container involving the abnormality. Thus, it is easier to achieve the purpose. Further, when the alert function is used for the purpose of notifying the user that the container 10 in which an abnormality may have occurred is conveyed, the alert information may be output, according to the container identifier of the container 10, to the notification device 700 corresponding to the seat to which the container 10 is currently or will be conveyed or the alert information may include information for identifying the container 10 in which the abnormality occurred. Therefore, it is possible to limit the target seats for which notification is made while achieving the purpose.

For example, when outputting the alert information for the purpose of notifying the user that the container 10 in which an abnormality may have occurred is be conveyed, the alert screen 82 based on the alert information is described, for example, as follows.

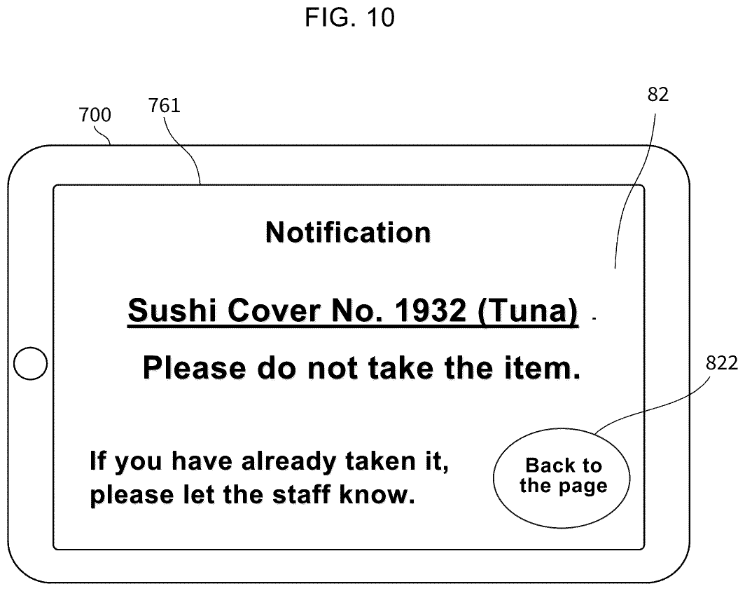

FIG. 10 is a diagram illustrating another example of a screen in which a notification based on the alert information is performed in the notification device 700.

Here, for example, an example of an alert screen 82 based on the alert information displayed on the notification display device 761 of the notification device 700 disposed at the user's seat is shown. The alert screen 82 shows, for example, “Sushi cover No. 1932 (tuna)” to indicate information related to the detected container 10 together with a message that the container 10 should not be used because an abnormality may occur in the container 10. In the alert screen 82, a confirmed button 822 is included, and the screen is switched from the alert screen 82 to a regular screen through which an order is placed by operating the confirmed button 812.

By outputting the alert screen 82, a use or the like who has seen the alert screen 82 can easily recognize that an abnormality may have occurred and confirm information for specifying the container 10 related to the abnormality.

### (Modifications)

When performing the alert function as described above, for example, a change in the state of the container 10 being conveyed through a seat may be detected even in the middle position of the corresponding section using detecting means different from the inter-seats detection units 970 described in the embodiment. Such a configuration (referred to as an intermediate detection mechanism for convenience) may be used together with a configuration (referred to as a both-ends detection mechanism) where the alert condition is determined based on the detection results of the state of the container 10 at both end points in the corresponding section using the above-described inter-seats detection units 970, the first detection unit 146, and the second detection unit 147 or may be used in place of the both-ends detection mechanism. In the following description, both the both-ends detection mechanism and the intermediate detection mechanism as described above are used.

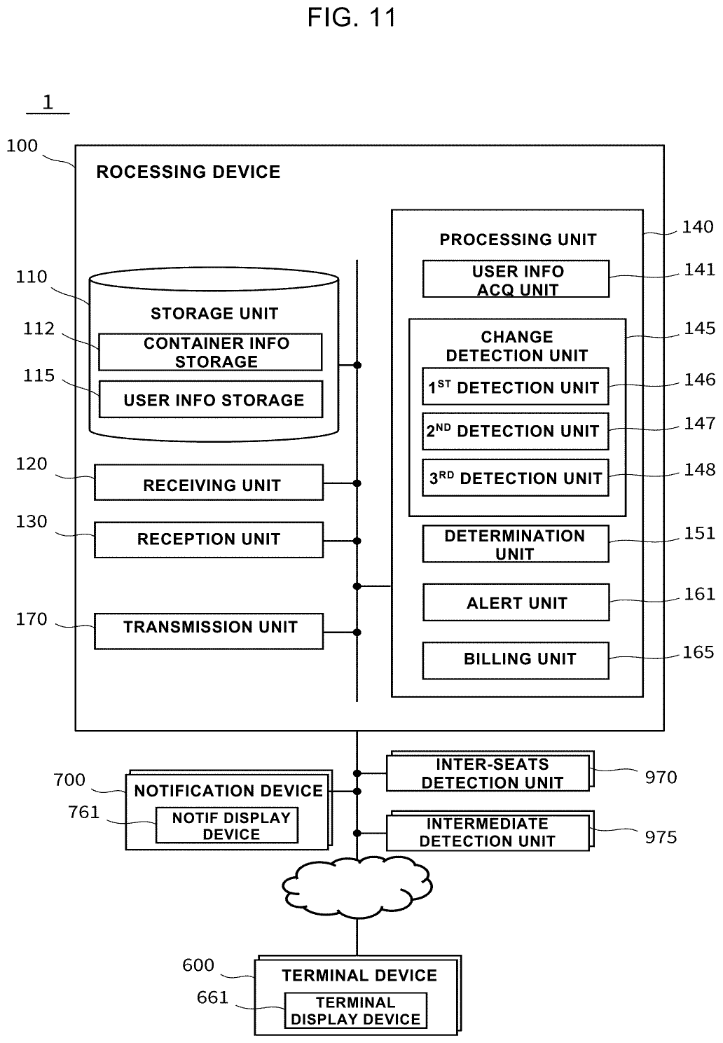

FIG. 11 is a block diagram of the restaurant system 1 according to a modification to the present embodiment.

In the present embodiment, the restaurant system 1 includes an intermediate detection unit 975. Further, in an information processing device 100, a change detection unit 145 of a processing unit 140 includes a third detection unit 148 that performs processing related to the intermediate detection unit 975 in addition to the first detection unit 146 and the second detection unit 147. Other basic configurations are the same as those in the above-described embodiments.

The intermediate detection unit 975 is disposed, for example, in each seat. The intermediate detection unit 975 includes, for example, a camera having field of view covering the container 10 located within the corresponding section of each seat. That is, the intermediate detection unit 975 is configured to acquire an image of the container 10 that is conveyed in the corresponding section of each seat. In other words, the intermediate detection unit 975 includes a camera capable of capturing an area through which the container 10 passes from a point entering the seat to a point exiting the seat. The camera of the intermediate detection unit 975 may be disposed, for example, above the table 980 of each seat, disposed in a partition between adjacent seats, or the like, or disposed in the upper unit 951, but is not necessarily limited to these. Two or more cameras may be included in the intermediate detection unit 975 for a seat. In a part area of the corresponding section, the camera may be disposed not to capture the container. That is, the camera may be disposed so that the container 10 in a predetermined area continuously or intermittently in the corresponding section is covered by the field of view. The camera may be a sensor such as LiDAR, and may acquire a distance image.

The intermediate detection unit 975 is configured to continuously detect each of the two or more containers 10 being conveyed on the conveying path 960 to acquire information related to the containers 10. In this modification, the intermediate detection unit 975 is disposed such that the intermediate detection unit 975 can continuously detect the open/close state of the cover 12 as to the container 10 located within the corresponding section based on the detection result by the camera of the intermediate detection unit 975. Continuously detecting includes, for example, performing detection at predetermined time intervals. The intermediate detection unit 975 can detect, for example, whether the cover 12 of the container 10 is opened or closed. Detecting the open/close state using the images may be performed by acquiring information indicating whether the cover 12 is opened or closed output from a machine learning learner or by performing other publicly-known image recognition technology. Detection using images captured by the intermediate detection unit 975 may be performed by the intermediate detection unit 975. In this case, the detection result by the intermediate detection unit 975 is output to the information processing device 100 or the like. Further, detection using the images captured by the intermediate detection unit 975 may be performed by the processing unit 140 of the information processing device 100, which will be described later. In this case, the images captured by the intermediate detection unit 975 and the information created based on the images are output from the intermediate detection unit 975 to the information processing device 100.

In the present modification, the container identifier for identifying the corresponding container 10 captured by the intermediate detection unit 975 may be acquired, for example, based on an image captured by the intermediate detection unit 975. Further, for example, by synchronizing the identification of the container identifier using the inter-seats detection unit 970 on the upstream side and the detection of the container 10 by the intermediate detection unit 975, etc., the container identifier of the corresponding container 10 captured by the intermediate detection unit 975 may be specified.

In this modification, the change detection unit 145 is configured to continuously detect a change in the open/close state of the cover 12 of the container 10 conveyed in the corresponding section using the third detection unit 148. As described above, continuously detecting includes, for example, performing detection at predetermined time intervals. In this modification, the third detection unit 148 is configured to detect the open/close state of the cover 12 of the container 10 based on an image captured by the camera of the intermediate detection unit 975. For the same container 10, when the detection result of the open/close state detected by the third detection unit 148 changes within the corresponding section, the change detection unit 145 is configured to detect this change. The third detection unit 148 may detect the open/close state based on the detection result by the camera of each intermediate detection unit 975, or the third detection unit 148 may acquire the detection result of the open/close state by each of the inter-seats detection units 970. Even in the latter case, it can be described that the third detection unit 148 detects the open/close state. Similarly, a change in the open/close state can be detected in each of the inter-seats detection units 970, and based on the detection result, the third detection unit 148, that is, the change detection unit 145, may detect a change in the open/close state.

In this modification, the following state change conditions are set as the alert condition in addition to, or in place of, those as described in the above-described embodiment. That is, the state change condition may be met when the change from the open state to the closed state of the cover 12 of the container 10 conveyed at a seat is detected. Since such an alert condition is defined, the determination unit 151 may determine that the alert condition is met when the change detection unit 145 detects that the state of the container 10 in the corresponding section changed from the open state to the closed state.

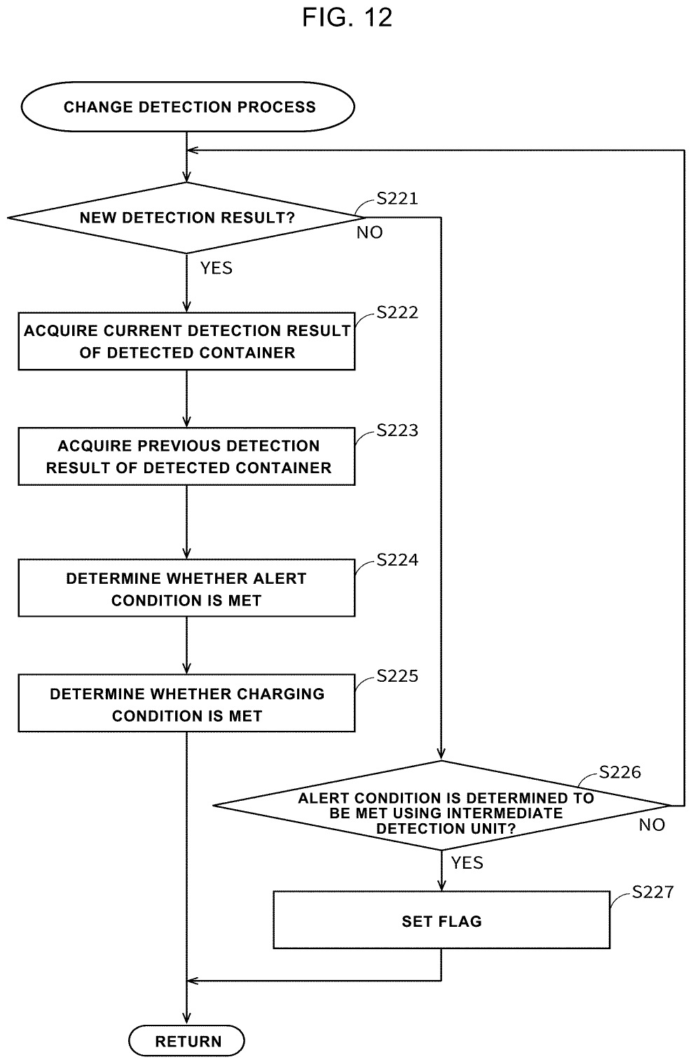

FIG. 12 is a flowchart illustrating one example of a change detection process in this modification.

As shown in step S221, in this modification, the processing unit 140 first determines whether a new detection result by the inter-seats detection unit 970 is present. If the new detection result is determined to be present, the process proceeds to step S222, and if not, the process proceeds to step S226.

The processes at steps S222 to S225 are the same as those at steps S122 to S125 in the above-described embodiment. When step S225 is completed, the process returns to the upstream process.

(Step S226) The processing unit 140 determines whether the alert condition is met using the intermediate detection unit 975. For example, the processing unit 140 determines whether a state change from the closed state to the open state is detected for any of the containers 10. If the alert condition is determined to be met, the process proceeds to step S227, otherwise the process proceeds to step S221.

(Step S227) The processing unit 140 stores the determination result that the alert condition is met in the storage unit 110 as a flag or the like associated with the container identifier of the container 10, for example. After that, the process returns to the upstream processes.

In this modification, the intermediate detection unit 975 is used to detect a change in the open/close state of the container 10 within the corresponding section and output alert information. Thus, the alert information can be output more quickly.

In the present modification, the alert condition may include a condition related to a combination of the detection result by the first detection unit 146 and the detection result by the third detection unit 148, or a condition related to a combination of the detection result by the third detection unit 148 and the detection result by the second detection unit 147. For example, the alert condition may be met when the closed state is detected by the third detection unit 148 for the container 10 for which the open state was detected by the first detection unit 146. In this case, it is also possible to output the alert information more quickly. Further, for example, the alert condition may be met when the closed state is detected by the second detection unit 148 for the container 10 for which the open state was detected by the first detection unit 147. In this case, for example, for the container 10 for which the closed state was detected by the first detection unit 146, it is possible to output the alert information when the container 10 is opened once in the middle of the corresponding section and then is closed again. The latter condition may be categorized into one type of conditions that the state of the cover 12 of the container 10 being conveyed at a seat changed from the open state to the closed state.

Further, in this modification, the intermediate detection unit 975 may include a camera configured to capture the inside of the container 10 in the same manner as the inter-seats detection unit 970. The camera may be a camera capable of capturing the inside of the container 10 when the cover of the container 10 is opened. The restaurant system 1 may continuously detect the state in the container 10 using an image captured by the camera of the intermediate detection unit 975. Such a detection may be performed by acquiring information indicating whether the cover 12 is opened or closed output from a machine learning learner or by performing other publicly-known image recognition technology. As described above, such a detection process may also be performed by the intermediate detection unit 975 itself, or may be performed by the information processing device 100 or the like.

In such a case, the change detection unit 145 may continuously detect a change in the presence and absence state of an item for a container 10 in the corresponding section using the third detection unit 148. As an alert condition, for example, by setting a condition that an absence of an item 5 is detected when the container 10 is conveyed in a middle region of the corresponding section but, thereafter, a presence of the item 5 is detected, the alert information can be quickly output when an abnormality by someone returning an item 5 or the like into the container 10 may have occurred.

Further, as another modification (may be referred to as a second modification), the above-described alert function may be realized by using a container 10B capable of detecting the open/close state of the cover 12 unlike the above-described embodiment. Since the open/close state can be detected by the container 10B itself, it is possible to detect a change in the state of the container 10B conveyed at a seat even in the middle area of the corresponding section. Such a configuration (referred to as a “container detection mechanism” for convenience) may be used in combination with the both-ends detection mechanism as described above, or may be used in place of the both-ends detection mechanism. Further, the container detection mechanism may be used in combination with the intermediate detection mechanism as described in the modification. In the following description, the both-ends detection mechanism and the container detection mechanism are used. If the both-ends detection mechanism and the intermediate detection mechanism are not used, a mechanism where the position of each container 10B on the conveying path 960 is continuously detectable may be used. As one example, it is possible to specify a positional relationship between each seat in the restaurant and each container 10B using relative position information indicating the position of each container 10B starting from a predetermined position on the conveying path 960 and information indicating the absolute position of a particular position on the transfer path 960.

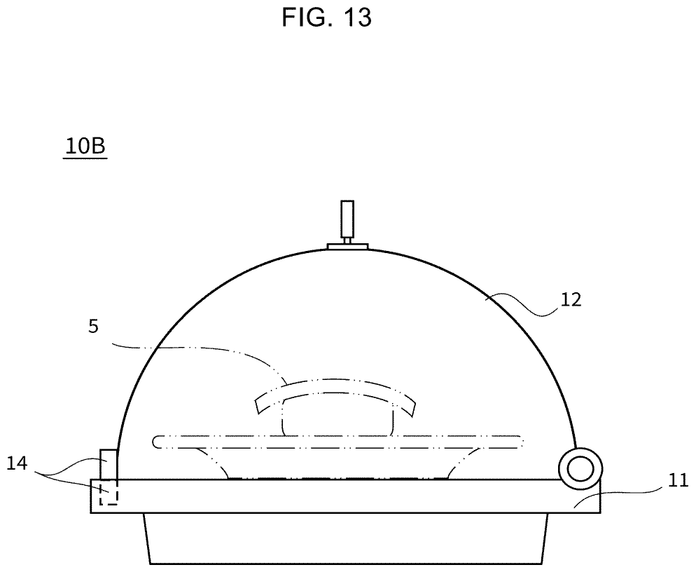

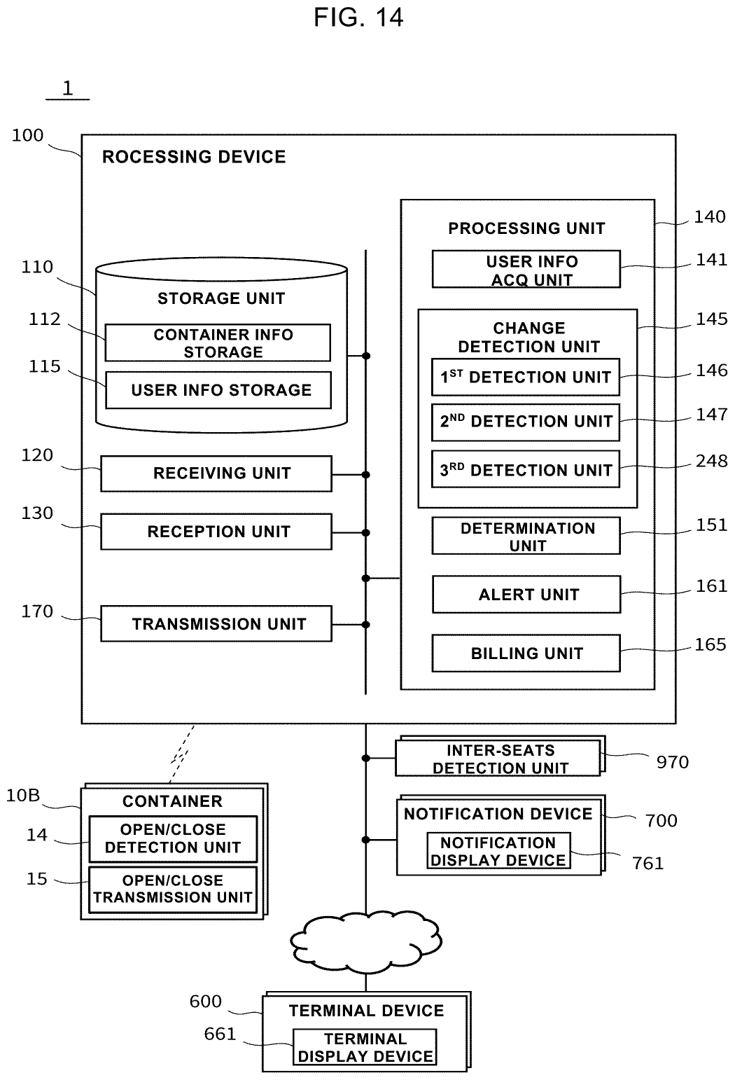

FIG. 13 is a side view showing a schematic configuration of the container 10B used in the restaurant system 1 according to another modification to the present embodiment. FIG. 14 is a block diagram of the restaurant system 1.

The container 10B includes, for example, an open/close detection unit 14 and an open/close transmission unit 15. The open/close detection unit 14 detects the open/close state of the cover 12 of the container 10B or a change thereof. The open/close detection unit 14 is configured to output an open/close signal indicating the open/close state of the cover 12 or a detection result of a change thereof. The open/close transmission unit 15 is configured to wirelessly communicate with the information processing device 100 and other devices of the restaurant system 1, and the open/close signal output by the open/close detection unit 14 is transmitted to the information processing device 100. The open/close transmission unit 15 may include, for example, a communication module capable of wirelessly communicating, a power supply thereof, and the like. However, the communication method may be appropriately selected. The open/close signal may be a signal indicating at least one of an open state and a closed state or may be a signal indicating that a state change between the open state and the closed state is detected. Further, the open/close signal may be a signal transmitted only when the state change from the open state to the closed state is detected.

The open/close detection unit 14 is, for example, disposed over the base 11 and the cover 12, and is capable of outputting a signal according to the detection result of whether one is in close proximity or distance from the other, but is not necessarily limited to this. The open/close detection unit 14 may be a switch or the like disposed in one of the base 11 and the cover 12, and the switch is configured to output a signal that changes according to changes of the position of a part of the cover 12 when the cover 12 is opened or closed. Further, the detection unit 14 may be a switch or the like that is configured to output a signal that changes according to the rotation angle of the cover 12 with respect to the base 11. Further, the detection unit 14 may be a sensor or the like that measures acceleration at a predetermined position of the cover 12 and outputs a signal indicating the measurement result or the processing result. The open/close detection unit 14 may be disposed, for example, in a hinge by which the mounting table 11 and the cover 12 are connected to each other, or may be disposed at a position away from the hinge. In addition, a switch or the like configured to output a signal according to the presence or absence of an item 5 may be used as the open/close detection unit 14 or in addition to the unit 14.

In the second modification, the change detection unit 145 of the information processing device 100 has a third detection unit 248. The change detection unit 145 is configured to continuously detect a change in the open/close state of the cover 12 of the container 10 conveyed in the corresponding section using the third detection unit 248. As described above, continuously detecting includes, for example, performing detection at predetermined time intervals. In the second modification, the third detection unit 248 is configured to detect a change in the open/close state of the cover 12 of the container 10 based on the open/close signals transmitted from each of the containers 10B. For the same container 10, when the detection result of the open/close state detected by the third detection unit 248 changes within the corresponding section, the change detection unit 145 is configured to detect this change.

In the second modification, the container identifier for each container 10B may be acquired by the change detection unit 145 using, for example, the container identifier transmitted in association with the open/close signal.

In the second modification, the same as described in the intermediate detection mechanism described above can be used for the alert condition and the change detection process. In this way, a change in the open/close state of the container 10 within the corresponding section can be continuously detected using information acquired from the container 10B and the alert information can be output. Thus, the alert information can be output more accurately.

Note that the container 10B may not necessarily be configured to communicate with the information processing device 100. For example, the container 10B may have an information output unit that outputs information indicating a detection result by the open/close detection unit 14 by displaying information or lighting a lamp in a manner according to the open/close signal output from the open/close detection unit 14. In this case, the third detection unit 248 may detect a change in the open/close state of the cover 12 of the container 10B using the result obtained by a camera or the like as the output result of the information output unit.

### (Others)

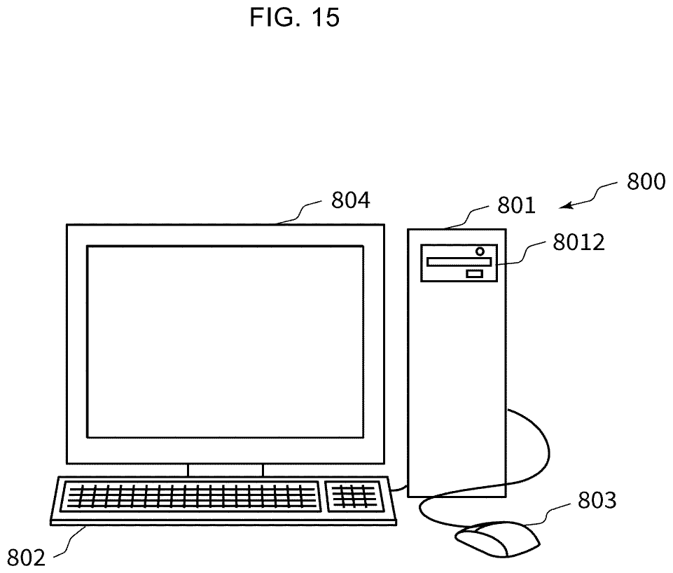

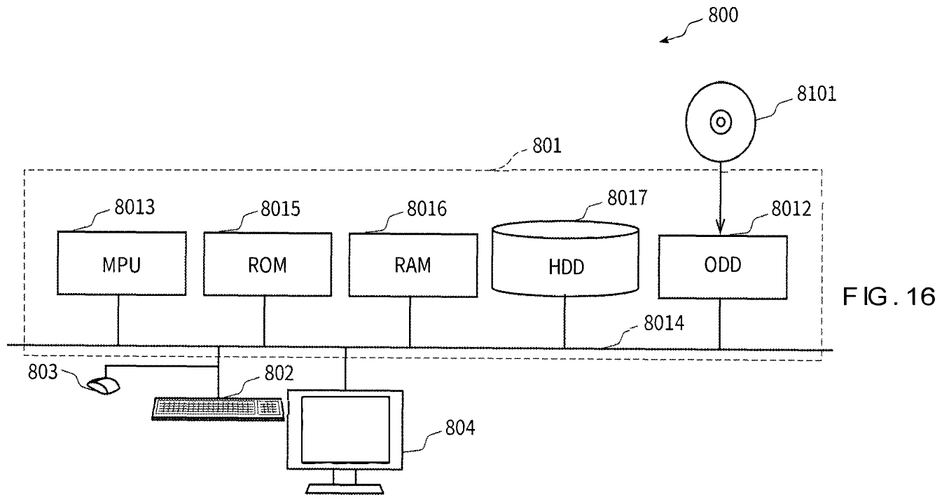

FIG. 15 is an overview view of a computer system 800 in the above embodiment. FIG. 16 is a block diagram of the computer system 800.

The figures illustrate one example of a computer that executes the program described herein to realize the information processing device 100 or the like of the restaurant system 1 of the above-described embodiment. The above embodiments can be implemented with computer hardware and a computer program running on the hardware.

The computer system 800 includes a computer 801 that includes an optical disc drive, a keyboard 802, a mouse 803, and a monitor 804.

In addition to the optical disc drive (ODD) 8012, the computer 801 is connected to a MPU8013, a bus 8014 connected to the optical disc drive 8012, etc., and a ROM8015 for storing programs such as a boot-up program MPU8013, a RAM8016 for temporarily storing instructions of an application program and providing a temporary storage space, and a hard disk (HDD) 8017 for storing an application program, a system program, and data. Although not shown herein, the computer 801 may further include a network card that provides a connection to a LAN.

A program that causes the computer system 800 to execute a function of the information processing device of the above-described embodiment may be stored in the optical disk 8101, inserted into the optical disk drive 8012, or transferred to the hard disk 8017. Alternatively, the program may be transmitted to the computer 801 over a network not shown and stored on the hard disk 8017. The program is loaded into the RAM8016 when executed. The program may be loaded directly from the optical disc 8101 or the network.

The program does not necessarily include a third-party program or an operating system (OS) that causes the computer 801 to perform functions of the information processing device or the like in the above-described embodiments. The program may include only a portion of instructions that invoke the appropriate function (module) in a controlled manner to acquire the desired result. How the computer system 800 operates is well known, and a detailed description is omitted.

In the above program, the transmission step for transmitting information, the receiving step for receiving information, and the like include processing performed by hardware, for example, a modem or an interface card in the transmission step (processing performed only by hardware).

Further, the computer that executes the program may be singular or plural. That is, centralized processing may be performed, or distributed processing may be performed.

Further, in the above embodiment, two or more components present in one device may be physically realized in one medium.

In the above embodiment, each component may be configured by dedicated hardware, or for a component that can be realized by software, such a component may be realized by executing a program. For example, each component can be realized by a program execution unit such as a CPU reading and executing a software program recorded on a recording medium such as a hard disk or semiconductor memory. At the time of execution, the program execution unit may execute the program while accessing the storage unit or the storage medium. Further, the program may be executed by downloading from a server or the like, and may be executed by reading a program stored on a predetermined storage medium (for example, an optical disk, a magnetic disk, a semiconductor memory, etc.). Further, this program may be used as a program constituting a program product. Further, the computers that execute the program may be singular or plural. That is, centralized processing may be performed, or distributed processing may be performed.

Further, in the above embodiment, each process (each function) may be realized by centralized processing by a single device (system) or may be realized by being distributed by a plurality of devices (in this case, the entire system composed of a plurality of devices that perform distributed processing may be recognized as one “device”).

Further, in the above embodiment, the transfer of information between each component may be performed, for example, when the two components that pass the information are physically different, by the output of information by one component and the reception of information by the other component. Alternatively, when the two components performing the transfer of information therebetween can be treated as the physically same, the transfer of information may be performed by shifting from the phase of processing on one component to the phase of processing on the other component.

Further, in the above embodiment, information related to the processing performed by each component (for example, information received, acquired, selected, generated, transmitted, received by each component), threshold values used by each component in processing, mathematical formulas, addresses, etc. may be stored for a long time, although not explicitly described. Further, each component or an accumulating unit (not shown) may accumulate information on the recording medium (not shown). Further, each component or a readout unit (not shown) may read out information from the storage medium (not shown).

Further, in the above embodiment, when information such as information used in each component or the like, such as threshold values, addresses, and various setting values used by each component in processing, may be changed by a user, the user may be able to change the information as appropriate, even if it is not specified in the above description. If the information can be changed by a user, the change may be realized, for example, by a non-illustrated reception unit that receives a change instruction from the user and a non-illustrated change unit that changes the information in response to the change instruction. The reception of the change instruction by the reception unit not shown may be, for example, acceptance from an input device, reception of information transmitted via a communication line, or acceptance of information read from a predetermined recording medium.

The present disclosure is not necessarily limited to the above embodiments, but can be modified in various ways, and they are also included within the scope of the present invention.

An embodiment may be constructed in which the components of the above-described embodiment or modifications are appropriately combined. For example, it is not limited to the configuration of the above-described embodiment itself, and each component of the above-described embodiment or modification may be appropriately substituted or combined with components such as other embodiments. Further, among the above-described embodiments and modifications, some components and functions may be omitted.

As described above, the restaurant system according to the present disclosure can call attention to a possibility that an abnormality related to the container may have occurred when there is a possibility that an abnormality related to the container has occurred, and is useful as a restaurant system or the like.

1. A restaurant system that provides an item to a seat used by a user in a restaurant, the restaurant system comprising:
a container that has a cover and is configured to house an item, the cover being selectively opened and closed;
a conveying device that is configured to convey the item housed in the container;
a change detection unit that is configured to detect, for the seat, a change in a state of the container that is being conveyed by the conveying device;
a determination unit that is configured to determine whether a predetermined alert condition is met based on a detection result of the change detection unit; and
an alert unit that is configured to output alert information indicating that an abnormality related to the container may have occurred upon determining that the alert condition is met by the determination unit.

2. The restaurant system according to claim 1, further comprising
an inter-seats detection unit that is disposed along a conveying path of the conveying device, the inter-seats detection unit having a sensor that is configured to detect the container, wherein
the change detection unit includes:
a first detection unit that is configured to detect information related to the state of the container conveyed to approach the seat based on a detection result of the inter-seat detection unit; and
a second detection unit that is configured to detect information related to the state of the container conveyed to move away from the seat based on the detection result of the inter-seats detection unit.

3. The restaurant system according to claim 2, wherein
each of the first detection unit and the second detection unit is configured to detect an open/close state of the cover of the container, and
the alert condition is met when, for the container conveyed to the seat, the first detection unit detects an open state of the cover and the second detection unit detects a closed state of the cover.

4. The restaurant system according to claim 2, wherein
the inter-seats detection unit includes a camera that is configured to capture an image of an inside of the container when the cover of the container is opened, and
each of the first detection unit and the second detection unit is configured to detect information related to the state of the container based on the image captured by the camera of the inter-seats detection unit.

5. The restaurant system according to claim 4, wherein
each of the first detection unit and the second detection unit is configured to detect information related to presence or absence of the item in the container based on the image captured by the camera, and
the alert condition is met when, for the container conveyed to the seat, the first detection unit detects absence of the item in the container and the second detection unit detects presence of the item in the container.

6. The restaurant system according to claim 1, wherein
the change detection unit is configured to continuously detect a change in an open/close state of the cover of the container that is being conveyed by the conveying device to the seat, and
the alert condition is met when the open/close state of the cover of the container conveyed to the seat is detected to change from an open state to a closed state.

7. The restaurant system according to claim 6, further comprising
an intermediate detection unit that has a camera configured to capture an image of an area through which the container passes after the container reached the seat until the container is conveyed out from the seat, wherein
the change detection unit is configured to detect a change in the open/close state of the cover of the container based on the image captured by the camera of the intermediate detection unit.

8. The restaurant system according to claim 6, wherein
the container has an open/close detection unit that is configured to detect the open/close state of the cover or a change in the open/close state, and
the change detection unit is configured to acquire information indicating a detection result by the open/close detection unit.

9. The restaurant system according to claim 1, wherein
the change detection unit is configured to specify a container identifier for identifying the container as a detection target, and
the alert unit is configured to output the alert information on the container identified by the container identifier in an output mode corresponding to the container identifier specified by the change detection unit.

10. The restaurant system according to claim 9, wherein
the alert unit is further configured to output the alert information including information corresponding to the container identifier specified by the change detection unit as the alert information related to the container identified by the container identifier.

11. The restaurant system according to claim 9, wherein
the alert unit is configured to output the alert information on the container identified by the container identifier to an output destination corresponding to the container identifier specified by the change detection unit.

12. The restaurant system according to claim 1, further comprising
a billing unit that is configured to charge the user corresponding to the seat based on a detection result of the change detection unit.

13. An alerting method implemented by a restaurant system including: a container that houses an item with a cover; a conveying device that conveys the item housed in the container; and a display device, the alerting method comprising:
a change detection step of detecting, for a seat, a change in a state of the container that is being conveyed by the conveying device;
a determination step of determining whether a predetermined alert condition is met based on a detection result at the change detection step; and
an alert step of outputting, to the display device, alert information indicating that an abnormality related to the container may have occurred upon determining that the alert condition is met at the determination step.

14. A non-transitory, computer readable, storage medium storing an alerting program for a restaurant system including: a container that houses an item with a cover; a conveying device that conveys the item housed in the container; and a display device, the alerting program, when executed by at least one processor of the restaurant system, causing the at least one processor to perform:
a change detection step of detecting, for a seat, a change in a state of the container that is being conveyed by the conveying device;
a determination step of determining whether a predetermined alert condition is met based on a detection result at the change detection step; and
an alert step of outputting, to the display device, alert information indicating that an abnormality related to the container may have occurred upon determining that the alert condition is met at the determination step.
